(19) United States
(12) Patent Application Publication
(10) Pub. No.: US 2016/0011336 A1
(43) Pub. Date: Jan. 14, 2016

(54) INFRARED ABSORBING COMPOSITIONS, INFRARED CUT FILTERS, CAMERA MODULES AND PROCESSES FOR MANUFACTURING CAMERA MODULES

(71) Applicant: FUJIFILM Corporation, Tokyo (JP)

(72) Inventors: Hideki TAKAKUWA, Haibara-gun (JP); Toshihide EZOE, Haibara-gun (JP); Hidenori TAKAHASHI, Haibara-gun (JP); Kazuto SHIMADA, Haibara-gun (JP)

(73) Assignee: FUJIFILM Corporation, Tokyo (JP)

(21) Appl. No.: 14/861,444

(22) Filed: Sep. 22, 2015

Related U.S. Application Data
(63) Continuation of application No. PCT/JP2014/058456, filed on Mar. 26, 2014.

(30) Foreign Application Priority Data
Mar. 27, 2013 (JP) 2013-066658

(51) Int. Cl. G02B 1/04; G02B 5/20; G02B 5/22

(52) U.S. Cl. CPC G02B 1/04; G02B 5/223; G02B 5/208

(57) ABSTRACT

Provided are infrared absorbing compositions that allow for preparing infrared absorption patterns having good adhesiveness to substrates on which the infrared absorbing composition is applied. The infrared absorbing composition contains an infrared absorbing material, and a polymerizable compound containing a partial structure represented by formula (1) below: wherein R¹ represents a hydrogen atom or an organic group; the asterisk (*) indicates a point of attachment to another atom.

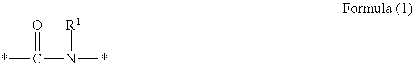

### CROSS-REFERENCE TO RELATED APPLICATIONS

This application is a Continuation of PCT International Application No. PCT/JP2014/058456 filed on Mar. 26, 2014, which claims priority under 35 U.S.C §119(a) to Japanese Patent Application No. 2013-066658 filed on Mar. 27, 2013. Each of the above application(s) is hereby expressly incorporated by reference, in its entirety, into the present application.

### TECHNICAL FIELD

The present invention relates to infrared absorbing compositions, infrared cut filters, camera modules and processes for manufacturing camera modules.

### BACKGROUND ART

Among infrared absorbing materials, infrared absorbing dyes are applied to various purposes in a wide range of fields.

For example, infrared absorbing dyes are used as infrared cut filters for plasma display panels (PDPs) and solid-state image sensors such as CCDs; or as optical filters in thermal radiation shielding films; or as photothermal conversion materials in write-once optical discs (CD-R) and flash fusing/fixing materials (e.g., see patent document 1).

Especially, it is difficult to correctly separate light into colors by solid-state image sensors such as CMOSs and CCDs incorporated into cameras because they also have high sensitivity to light in the infrared region (700 nm to 1100 nm) To avoid an incorrect color separation, reflective infrared absorbing filters and absorptive infrared absorbing filters using inorganic ions or organic dyes are typically inserted into optical systems of cameras. However, it is substantially impossible to switch on and off such infrared cut filters for every pixel, and they cannot be used for applications in which, for example, a visible light image and an infrared light image are captured at the same time because they are attached to the entire surface of camera lenses.

### REFERENCES

### Patent Documents

Patent document 1: JPA2011-68731.

### SUMMARY OF THE INVENTION

### Problems to be Solved by the Invention

Our research revealed that there is a demand for infrared absorbing compositions that allow for preparing infrared absorption patterns having good adhesiveness to substrates on which the infrared absorbing composition are applied.

The present invention aims to provide infrared absorbing compositions that allow for preparing infrared absorption patterns having good adhesiveness to substrates on which the infrared absorbing composition are applied.

### Means for Solving the Problems

As a result of our careful studies under these circumstances, we accomplished the present invention on the basis of the finding that the problems described above can be solved by an infrared absorbing composition compounding an infrared absorbing material and a polymerizable compound having a specific a partial structure.

Specifically, the problems were solved by the solving means <1>, preferably by solving means <2> to <16> below.

<1> An infrared absorbing composition comprising: an infrared absorbing material, and a polymerizable compound containing a partial structure represented by formula (1) below:

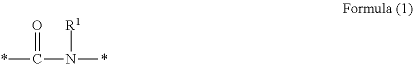

wherein R¹ represents a hydrogen atom or an organic group; the asterisk (*) indicates a point of attachment to another atom.
   <2> The infrared absorbing composition according to <1>, wherein the polymerizable compound contains two or more partial structures represented by formula (1).
   <3> The infrared absorbing composition according to <1> or <2>, wherein the polymerizable compound contains two or more polymerizable functional groups.
   <4> The infrared absorbing composition according to <1>, wherein the polymerizable compound is a polymerizable compound containing two or more partial structures represented by formula (1-1):

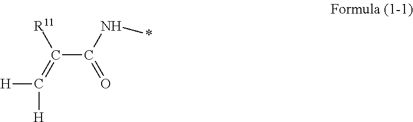

wherein R¹¹ represents a hydrogen atom or methyl group; the asterisk (*) indicates a point of attachment to another atom.
<5> The infrared absorbing composition according to <1>, wherein the polymerizable compound is represented by formula (1-2):

A¹-C-(L¹-A¹)₃ Formula (1-2)

wherein A¹ each independently represents a partial structure represented by formula (1-1), and L¹ represents a divalent linking group:

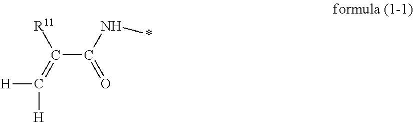

wherein R¹¹ represents a hydrogen atom or methyl group; the asterisk (*) indicates a point of attachment to another atom.

<6> The infrared absorbing composition according to <1>, wherein the polymerizable compound is represented by formula

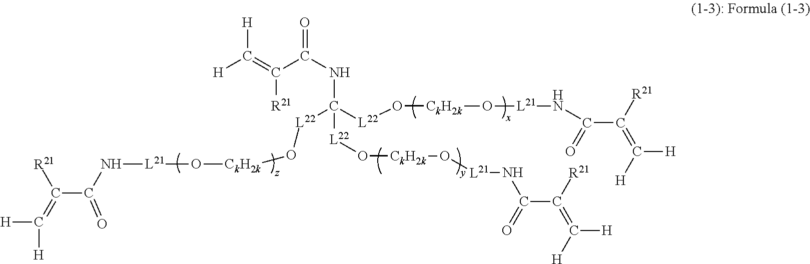

wherein R²¹ each independently represents a hydrogen atom or methyl group; L²¹ represents a straight-chain or branched alkylene group containing 2 to 4 carbon atoms, provided that L²¹ does not adopt a structure in which an oxygen atom and a nitrogen atom at both ends of L²¹ are attached to the same carbon atom of L²¹; L²² represents a divalent linking group; k represents 2 or 3; x, y and z each independently represent an integer of 0 to 6, provided that x+y+z satisfies 0 to 18.
<7> The infrared absorbing composition according to any one of
>2> to <6>, wherein the infrared absorbing material is at least one of a copper compound and a pyrrolopyrrole dye.
<8> The infrared absorbing composition according to <6> or <7>, wherein the infrared absorbing material is a pyrrolopyrrole dye; and the polymerizable compound is represented by formula (1-3).
<9> The infrared absorbing composition according to <7> or <8>, wherein the pyrrolopyrrole dye is a compound represented by formula (I) below:

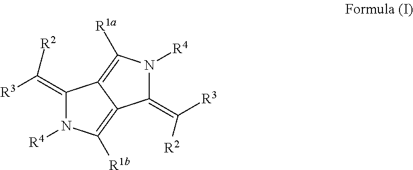

wherein R^{1a} and R^{1b} each independently represent an alkyl group, aryl group or heteroaryl group; R² and R³ each independently represent a hydrogen atom or a substituent and at least one of R² and R³ represents an electron-withdrawing group, or R² and R³ may be joined together to form a ring; R⁴ represents a hydrogen atom, an alkyl group, an aryl group, a heteroaryl group, a substituted boron atom or a metal atom, and may form a covalent bond or a coordinate bond with at least one of R^{1a}, R^{1b} and R³.
<10> The infrared absorbing composition according to any one of <1> to <9>, wherein the infrared absorbing material has a maximum absorption at a wavelength of 820 to 880 nm.
<11> The infrared absorbing composition according to any one of <1> to <10>, further comprising a solvent.
<12> The infrared absorbing composition according to any one of <1> to <11>, which has a solid content 5 to 50% by mass in the infrared absorbing composition.
<13> An infrared cut filter using the infrared absorbing composition according to any one of <1> to <12>.
<14> A process for manufacturing the infrared cut filter according to <13>, comprising:

applying the infrared absorbing composition to form an infrared absorption pattern,

wherein the infrared absorbing composition contains water or an aqueous solvent.

<15> A camera module comprising a solid-state image sensor board, and the infrared cut filter according to <13>.
<16> A process for manufacturing a camera module comprising a solid-state image sensor board and an infrared cut filter, the process comprising:

coating the infrared absorbing composition according to any one of <1> to <12>.

### Advantages of the Invention

The present invention makes it possible to provide infrared absorbing compositions that allow for preparing infrared absorption patterns having good adhesiveness to substrates on which the infrared absorbing composition are applied.

### BRIEF EXPLANATION OF THE DRAWINGS

FIG. 1 is a schematic sectional diagram showing the structure of a camera module comprising a solid-state image sensor according to an embodiment of the present invention.

FIG. 2 is a schematic sectional diagram of a solid-state image sensor board according to an embodiment of the present invention.

### THE MOST PREFERRED EMBODIMENTS OF THE INVENTION

The present invention will be detailed below. Note in this specification that the wording “to” with preceding and succeeding numerals is used for indicating a numerical range with the lower and upper limits thereof respectively given by these numerals. “An organic EL device” in the present invention means “an organic electroluminescent device”.

In this specification, “(meth)acrylate” means acrylate and methacrylate, “(meth)acryl” means acryl and methacryl, “(meth)acryloyl” means acryloyl and methacryloyl.

In this specification, the term “monomer” and “monomer” is synonymous. The monomer in the present invention is discriminated from oligomer and polymer, and means any compound having a weight-average molecular weight of 2,000 or smaller.

In this specification, the polymerizable compound means any compound having a polymerizable functional group, and may be a monomer or polymer. The polymerizable functional group means any group participating a polymerization reaction.

In the nomenclature of group (atomic group) in this specification, any expression without indication of “substituted” or “unsubstituted” includes both cases having no substituent and having a substituent.

Infrared ray in the present invention means a light having a maximum absorption (λmax) in a wavelength region of 700 to 1000 nm.

### [Infrared Absorbing Compositions]

The infrared absorbing compositions of the present invention comprise an infrared absorbing material, and a polymerizable compound containing a partial structure represented by formula (1) below:

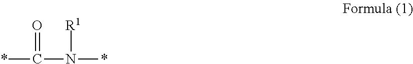

In formula (1), R¹ represents a hydrogen atom or an organic group. The asterisk (*) indicates the point of attachment to another atom.

The present invention makes it possible to provide infrared absorbing compositions that allow for preparing infrared absorption patterns having good adhesiveness to substrates on which the infrared absorbing composition are applied.

Preferably, the compositions of the present invention have a solids content of 5 to 50% by mass, more preferably 10 to 30% by mass in the compositions of the present invention.

### <Infrared Absorbing Material>

The infrared absorbing material used in the compositions of the present invention is not specifically limited so far as it typically has a maximum absorption in a wavelength region of 700 to 1000 nm, preferably 800 to 900 nm, but it is preferably a copper compound and/or an organic infrared absorbing dye as described below, more preferably a copper compound and/or a pyrrolopyrrole dye as described below.

Only one or more than one infrared absorbing material may be contained.

### <<Infrared Absorbing Dyes>>

The infrared absorbing dye typically has a maximum absorption in a wavelength region of 700 to 1000 nm, preferably 820 to 880 nm. In an alternative embodiment, the infrared absorbing dye selectively absorbs infrared rays in a wavelength region of 700 nm or more and 1000 nm or less. For example, the infrared absorbing dye has a maximum absorption in a wavelength region of 820 to 880 nm, and preferably absorbs 10% or less, more preferably 7% or less, even more preferably 5% or less of infrared rays at a wavelength of less than 820 nm and more than 880 nm.

The molar absorption coefficient e of the infrared absorbing dye is not specifically limited, but preferably 50,000 to 500,000, more preferably 100,000 to 300,000.

Such infrared absorbing dyes may be either organic infrared absorbing dyes or inorganic infrared absorbing dyes. Organic infrared absorbing dyes include pyrrolopyrrole dyes and cyanine dyes. Cyanine dyes can be found in, for example, “Functional dyes by M. Okawara, M. Matsuoka, T. Kitao, and T. Hirashima, published by Kodansha Scientific Ltd.”, the disclosure of which is incorporated herein by reference. Further, organic infrared absorbing dyes also include the phthalocyanine compounds described in paragraph numbers 0013 to 0029 of Japanese Patent Application No. 2012-059737 and paragraph numbers 0010 to 0019 of Japanese Patent Application No. 2012-043917, the disclosures of which are incorporated herein by reference.

Especially, organic infrared absorbing dyes used in the present invention preferably include pyrrolopyrrole dyes, preferably compounds represented by formula (I) below. When pyrrolopyrrole dyes are used, the advantages of the present invention are achieved more effectively.

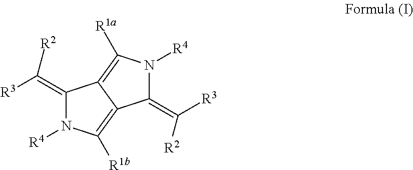

wherein R^{1a} and R^{1b} each independently represent an alkyl group, aryl group or heteroaryl group. R² and R³ each independently represent a hydrogen atom or a substituent and at least one of R² and R³ represents an electron-withdrawing group, or R² and R³ may be joined together to form a ring. R⁴ represents a hydrogen atom, an alkyl group, an aryl group, a heteroaryl group, a substituted boron atom or a metal atom, and may form a covalent bond or a coordinate bond with at least one of R^{1a}, R^{1b} and R³.

In formula (I), the alkyl group represented by R^{1a} and R^{1b} is preferably an alkyl group containing 1 to 30 carbon atoms, more preferably 1 to 20 carbon atoms, especially preferably 1 to 10 carbon atoms.

The aryl group represented by R^{1a} and R^{1b} is preferably an aryl group containing 6 to 30 carbon atoms, more preferably 6 to 20 carbon atoms, especially preferably 6 to 12 carbon atoms.

The heteroaryl group represented by R^{1a} and R^{1b} is preferably a heteroaryl group containing 1 to 30 carbon atoms, more preferably 1 to 12 carbon atoms. Hetero atoms include, for example, nitrogen, oxygen and sulfur atoms.

Especially, the group represented by R^{1a} and R^{1b} is preferably an aryl group substituted by an alkoxy group wherein the alkyl group is branched. The branched alkyl group preferably contains 3 to 30 carbon atoms, more preferably 3 to 20 carbon atoms.

The group represented by R^{1a} and R^{1b} is especially preferably 4-(2-ethylhexyloxy)phenyl, 4-(2-methylbutyloxy)phenyl, or 4-(2-octyldodecyloxy)phenyl, for example.

In formula (I), R^{1a} and R^{1b} may be identical to or different from each other.

R² and R³ each independently represent a hydrogen atom or a substituent T and at least one of them represents an electron-withdrawing group, or R² and R³ may be joined together to form a ring. The substituent T includes, for example, the following:

an alkyl group (preferably containing 1 to 30 carbon atoms), an alkenyl group (preferably containing 2 to 30 carbon atoms), an alkynyl group (preferably containing 2 to 30 carbon atoms), an aryl group (preferably containing 6 to 30 carbon atoms), an amino group (preferably containing 0 to 30 carbon atoms), an alkoxy group (preferably containing 1 to 30 carbon atoms), an aryloxy group (preferably containing 6 to 30 carbon atoms), an aromatic heterocyclyloxy group (preferably containing 1 to 30 carbon atoms), an acyl group (preferably containing 1 to 30 carbon atoms), an alkoxycarbonyl group (preferably containing 2 to 30 carbon atoms), an aryloxycarbonyl group (preferably containing 7 to 30 carbon atoms), an acyloxy group (preferably containing 2 to 30 carbon atoms), an acylamino group (preferably containing 2 to 30 carbon atoms), an alkoxycarbonylamino group (preferably containing 2 to 30 carbon atoms), an aryloxycarbonylamino group (preferably containing 7 to 30 carbon atoms), a sulfonylamino group (preferably containing 1 to 30 carbon atoms), a sulfamoyl group (preferably containing 0 to 30 carbon atoms), a carbamoyl group (preferably containing 1 to 30 carbon atoms), an alkylthio group (preferably containing 1 to 30 carbon atoms), an arylthio group (preferably containing 6 to 30 carbon atoms), an aromatic heterocyclylthio group (preferably containing 1 to 30 carbon atoms), a sulfonyl group (preferably containing 1 to 30 carbon atoms), a sulfinyl group (preferably containing 1 to 30 carbon atoms), a ureido group (preferably containing 1 to 30 carbon atoms), a phosphoric acid amide group (preferably containing 1 to 30 carbon atoms), a hydroxyl group, a mercapto group, a halogen atom, a cyano group, a sulfo group, a carboxyl group, a nitro group, a hydroxamic acid group, a sulfino group, a hydrazino group, an imino group, or a heterocyclyl group (preferably containing 1 to 30 carbon atoms).

At least one of R² and R³ is an electron-withdrawing group. Substituents having a positive Hammett op value (sigma-para value) typically act as electron-withdrawing groups. Electron-withdrawing groups preferably include cyano, acyl, alkyloxycarbonyl, aryloxycarbonyl, sulfamoyl, sulfinyl and heterocyclyl groups and the like, more preferably a cyano group. These electron-withdrawing groups may further be substituted.

In the present invention, examples of electron-withdrawing groups include substituents having a Hammett substituent constant op value of 0.2 or more. Preferably, the op value is 0.25 or more, more preferably 0.3 or more, especially preferably 0.35 or more. The upper limit is not specifically limited, but preferably 0.80.

Specific examples include cyano (0.66), carboxyl (—COOH: 0.45), alkoxycarbonyl (—COOMe: 0.45), aryloxycarbonyl (—COOPh: 0.44), carbamoyl (—CONH₂: 0.36), alkylcarbonyl (—COMe: 0.50), arylcarbonyl (—COPh: 0.43), alkylsulfonyl (—SO₂Me: 0.72), or arylsulfonyl (—SO₂Ph: 0.68) or the like. Especially preferred is cyano. In the formulae above, Me represents methyl and Ph represents phenyl.

The Hammett substituent constant op value can be found in, for example, paragraphs 0017 to 0018 of JPA2011-68731, the disclosure of which is incorporated herein by reference.

When R² and R³ are joined together to form a ring, they preferably form a 5- to 7-membered ring (preferably a 5- or 6-membered ring). Typically, the ring formed is preferably one of those used as acidic nuclei in merocyanine dyes, and specific examples can be found in, for example, paragraphs 0019 to 0021 of JPA2011-68731, the disclosure of which is incorporated herein by reference.

Especially, R³ preferably represents a heterocycle. Specifically, R³ preferably represents quinoline, benzothiazole or naphthothiazole.

In formula (I), the two R² groups may be identical to or different from each other, and the two R³ groups may also be identical to or different from each other.

When the group represented by R⁴ is an alkyl group, aryl group or heteroaryl group, this group is as defined for R^{1a} and R^{1b} and also covers the same preferred groups.

When the group represented by R⁴ is a substituted boron atom, the substituent is as defined above for the substituent T represented by R² and R³, preferably an alkyl group, aryl group, or heteroaryl group.

When the group represented by R⁴ is a metal atom, it is preferably a transition metal, especially preferably substituted boron. The substituted boron is preferably difluoroboron, diphenylboron, dibutylboron, dinaphthylboron, or catecholboron. Among them, diphenylboron is especially preferred.

R⁴ may form a covalent bond or a coordinate bond with at least one of R^{1a}, R^{1b} and R³, and especially R⁴ preferably forms a coordinate bond with R³.

Especially, R⁴ is preferably a hydrogen atom or a substituted boron atom (especially diphenylboron). In formula (I), the two R⁴ groups may be identical to or different from each other.

Compounds represented by formula (I) above used in the present invention can be found in, for example, paragraphs 0024 to 0052 of JPA2011-68731 (or [0043] to [0074] of the corresponding US Patent Application Publication No. 2011/0070407), the disclosure of which is incorporated herein by reference.

Preferably, the organic infrared absorbing dye used in the present invention is a compound represented by formula (I-1) below.

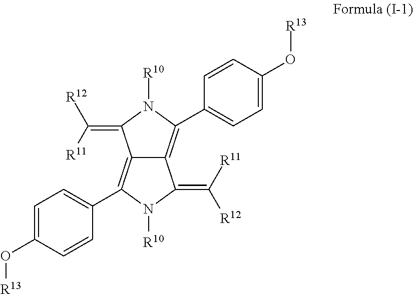

In formula (I-1), R¹⁰ each independently represents a hydrogen atom, an alkyl group, an aryl group, a heteroaryl group, a substituted boron atom or a metal atom, and may form a covalent bond or a coordinate bond with R¹². R¹¹ and R¹² each independently represent a hydrogen atom or a substituent and at least one of them represents an electron-withdrawing group, or R¹¹ and R¹² may be joined together to form a ring. R¹³ each independently represents a branched alkyl group containing 3 to 30 carbon atoms.

R¹⁰ has the same meaning as defined for R⁴ in formula (I) above, and also covers the same preferred ranges.

R¹¹ and R¹² have the same meanings as defined for R² and R³ in formula (I) above, and also cover the same preferred ranges. The R¹³ groups may be identical to or different from each other. Further, R¹³ is preferably an alcohol residue derived from, for example, isoeicosanol (FINEOXOCOL 2000 from Nissan Chemical Industries, Ltd.).

The alcohol may be straight-chain or branched, and it is preferably an alcohol containing 1 to 30 carbon atoms, more preferably an alcohol containing 3 to 25 carbon atoms, especially preferably a branched alcohol containing 3 to 25 carbon atoms. More specifically, it includes methanol, ethanol, isopropanol, n-butanol, tert-butanol, 1-octanol, 1-decanol, 1-hexadecanol, 2-methylbutanol, 2-ethylhexanol, 2-octyldodecanol, isohexadecanol (FINEOXOCOL 1600 from Nissan Chemical Industries, Ltd.), isooctadecanol (FINEOXOCOL 180 from Nissan Chemical Industries, Ltd.), isooctadecanol (FINEOXOCOL 180N from Nissan Chemical Industries, Ltd.), isooctadecanol (FINEOXOCOL 180T from Nissan Chemical Industries, Ltd.), isoeicosanol (FINEOXOCOL 2000 from Nissan Chemical Industries, Ltd.) or the like. These alcohols may be used as a mixture of two or more of them.

Especially, the organic infrared absorbing dye used in the present invention is more preferably a compound represented by formula (1-2) below.

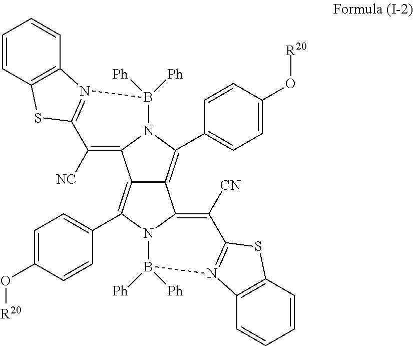

In formula (I-2), R²⁰ each independently represents a branched alkyl group containing 3 to 30 carbon atoms.

In formula (I-2), R²⁰ each independently represents a branched alkyl group containing 3 to 30 carbon atoms. R²⁰ has the same meaning as defined for R¹³ in formula (I-1) above, and also covers the same preferred ranges.

When the infrared absorbing dye in the compositions of the present invention is a pigment, the infrared absorbing dye is preferably used as a microparticle dispersion. The use of the infrared absorbing dye as a microparticle dispersion would have advantages such as improved durability of the infrared absorbing dye and a maximum absorption at a longer wavelength.

To improve the dispersion stability of the microparticle dispersion of the infrared absorbing dye, a dispersant is preferably added. Dispersants that can be used include hydroxyl-containing carboxylic acid esters, salts of long-chain polyaminoamides and high molecular weight acid esters, salts of high molecular weight polycarboxylic acids, salts of long-chain polyaminoamides and polar acid esters, high molecular weight unsaturated esters, high molecular weight copolymers, modified polyurethanes, modified polyacrylates, polyether ester anionic activators, naphthalenesulfonic acid/formaldehyde polycondensates, aromatic sulfonic acid/formaldehyde polycondensates, polyoxyethylene alkylphosphoric acid esters, polyoxyethylene nonylphenyl ethers, stearylamine acetate and the like.

The dispersants are preferably added at about 1 to 150 parts by mass per 100 parts by mass of the total of the infrared absorbing dye and the dispersion medium.

The use of an infrared absorbing dye as a microparticle dispersion can be found in, for example, paragraphs 0053 to 0058 of JPA2011-68731 (or [0075] to [0080] of the corresponding US Patent Application Publication No. 2011/0070407), the disclosure of which is incorporated herein by reference.

### <<Copper Compounds>>

The copper in the copper compound used in the present invention is not specifically limited so far as it has an absorption in the infrared region, but preferably monovalent or divalent copper, more preferably divalent copper.

The copper content in the copper compound used in the present invention is preferably 2 to 40% by mass, more preferably 5 to 40% by mass.

The copper compound used in the present invention is not specifically limited so far as it is a copper compound having a maximum absorption at a wavelength in the range of 700 nm to 1000 nm.

Preferably, the copper compound used in the present invention is a copper complex.

When the copper compound used in the present invention is a copper complex, the ligand L coordinated to copper is not specifically limited so far as it can form a coordinate bond with copper ions, and examples include phosphoric acids, phosphoric acid esters, phosphonic acids, phosphonic acid esters, phosphinic acids, substituted phosphinic acids, sulfonic acids, carboxylic acids, and compounds containing carbonyl (esters, ketones), amine, amide, sulfonamide, urethane, urea, alcohol or thiol and the like. Among them, preferred are phosphoric acids, phosphoric acid esters, phosphonic acids, phosphonic acid esters, phosphinic acids, substituted phosphinic acids, and sulfonic acids, more preferably phosphoric acid esters, phosphonic acid esters, substituted phosphinic acids, and sulfonic acids.

Specific examples of copper compounds used in the present invention include phosphorus-containing copper compounds, copper sulfonate compounds or copper compounds represented by formula (A) below. Phosphorus-containing copper compounds specifically include the compounds described at, for example, page 5, line 27 to page 7, line 20 of WO2005/030898, the disclosure of which is incorporated herein by reference.

Preferably, the copper compound used in the present invention is represented by formula (A) below:

Cu(L)ₙ₁.(X)ₙ₂ Formula (A)

In formula (A) above, L represents a ligand coordinated to copper, and X is absent or represents a halogen atom, H₂O, NO₃, ClO₄, SO₄, CN, SCN, BF₄, PF₆, BPh₄ (wherein Ph represents phenyl), or alcohol. n1 and n2 each independently represent an integer of 1 to 4.

The ligand L has a substituent containing an atom capable of being coordinated to copper such as C, N, O, or S, more preferably it has a group containing a lone pair of electrons such as N, O or S. It may contain one or more than one group capable of being coordinated to copper in the molecule, and may be dissociated or not. Preferred ligands L are as defined above for the ligand L. When the ligand is not dissociated, X is absent.

The copper complex used as an infrared absorbing material is in the form of a copper complex (copper compound) in which a ligand is coordinated to the central metal copper. The copper in the copper complex of the present invention is divalent copper, and such a complex can be produced by, for example, a reaction between a copper component and a ligand. Thus, any “infrared absorbing compositions containing copper and a ligand” are predicted to form a copper complex in the compositions.

Copper compounds used in the present invention and compounds forming the ligand L are explained in detail below.

### <<Phosphorus-Containing Copper Complexes>>

Phosphorus-containing copper complexes can be found in, for example, 0013 to 0030 of Japanese Patent Application No. 2013-030488, the disclosure of which is incorporated herein by reference.

Phosphorus-containing copper complexes are not specifically limited so far as they have a ligand containing a phosphorus compound, but preferably include phosphoric acid-copper complexes, phosphate ester-copper complexes, phosphonic acid-copper complexes, phosphonate ester-copper complexes, phosphinic acid-copper complexes, and substituted phosphinic acid-copper complexes, more preferably phosphate ester-copper complexes, phosphonate ester-copper complexes and substituted phosphinic acid-copper complexes.

### <<<Phosphate Ester-Copper Complexes>>>

Phosphate ester-copper complexes consist of copper as a central metal and a phosphate ester compound as a ligand. The phosphate ester compound forming the ligand L is more preferably a compound represented by formula (B) below:

(HO)ₙ—P(═O)—(OR²)₃₋ₙ Formula (B)

In formula (B) above, R² represents an organic group, and n represents 1 or 2. The organic group R² represents an alkyl group containing 1 to 18 carbon atoms, an aryl group containing 6 to 18 carbon atoms, an aralkyl group containing 1 to 18 carbon atoms, or an alkenyl group containing 1 to 18 carbon atoms, or —OR² represents a polyoxyalkyl group containing 4 to 100 carbon atoms, a (meth) acryloyloxyalkyl group containing 4 to 100 carbon atoms or a (meth) acryloylpolyoxyalkyl group containing 4 to 100 carbon atoms, and n represents 1 or 2. When n is 1, the R² groups may be identical to or different from each other.

Phosphate ester compounds used in the present invention include phosphate monoesters (represented by formula (B) above wherein n=2), and phosphate diesters (represented by formula (B) above wherein n=1), preferably phosphate diesters because of infrared radiation shielding ability and solubility, preferably a compound represented by formula (C) below:

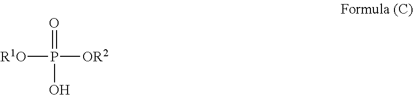

In formula (C), R¹ and R² each independently represent a monovalent organic group.

The compound represented by formula (C) above and salts thereof act as a ligand coordinated to copper. In this connection, the ligand refers to any of atoms other than the copper atom, ions, groups of atoms, radicals, neutral molecules and the like spatially arranged around the copper atom to bind to the copper atom in a copper complex.

In formula (C) above, R¹ and R² each independently represent a monovalent organic group. The monovalent organic group is preferably an organic group containing 3 or more carbon atoms, more preferably an organic group containing 5 or more carbon atoms, even more preferably an organic group containing 5 to 20 carbon atoms.

In formula (C) above, R¹ and R² may be joined together to form a cyclic structure. In this case, both R¹ and R² are divalent organic groups. The groups joined to form a cyclic structure (the divalent organic groups) are organic groups containing a total of 3 or more carbon atoms, preferably 5 or more carbon atoms, more preferably 5 to 20 carbon atoms.

Specific monovalent organic groups include, but not specifically limited to, straight-chain, branched or cyclic alkyl group, aryl group and heteroaryl group. These groups here may be linked via a divalent linking group (e.g., a straight-chain, branched or cyclic alkylene group, arylene group or heteroarylene group, —O—, —S—, —CO—, —COO—, —OCO—, —SO₂—, —NR— (wherein R represents a hydrogen atom or an alkyl group) or the like). Further, the monovalent organic group may be substituted.

Preferably, the straight-chain or branched alkyl group is an alkyl group containing 3 to 20 carbon atoms.

The cyclic alkyl group may be monocyclic or polycyclic.

Preferably, the cyclic alkyl group is a cycloalkyl group containing 3 to 20 carbon atoms.

Preferably, the aryl group is an aryl group containing 6 to 18 carbon atoms.

Preferably, the heteroaryl group is a 5-membered ring or 6-membered ring. Further, the heteroaryl group is a monocycle or a fused ring system, preferably a monocycle or a fused ring system composed of 2 to 8 rings, more preferably a monocycle or a fused ring system composed of 2 to 4 rings.

Specifically, a heteroaryl group derived fromamonocyclic or polycyclic aromatic ring containing at least one of nitrogen, oxygen, and sulfur atoms is used.

Straight-chain, branched or cyclic alkylene group, arylene group or heteroarylene group used as divalent linking groups include divalent linking groups derived by removing one hydrogen atom from the straight-chain, branched or cyclic alkyl, aryl group or heteroaryl group described above.

Examples of substituents by which the monovalent organic group may be substituted include alkyl groups, polymerizable groups (e.g., vinyl group, (meth)acryloyl group, epoxy group, oxetane group and the like), halogen atoms, carboxyl, carboxylate ester groups (e.g., —CO₂CH₃ and the like), hydroxyl, amide, haloalkyl groups (e.g., fluoroalkyl, chloroalkyl) and the like.

Alternatively, phosphate diester-copper complexes of the present invention contain a structure represented by formula (D) below:

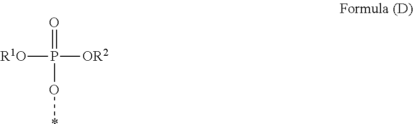

In formula (D), R and R² each independently represent a monovalent organic group. The asterisk (*) indicates the point of attachment to copper to form a coordinate bond.

In formula (D), R¹ and R² have the same meanings as defined for R¹ and R² in formula (C) above, and also cover the same preferred ranges.

The phosphate ester compound represented by formula (C) above preferably has a molecular weight of 200 to 1000, more preferably 250 to 750, even more preferably 300 to 500.

Specific examples of phosphate ester compounds are shown below.

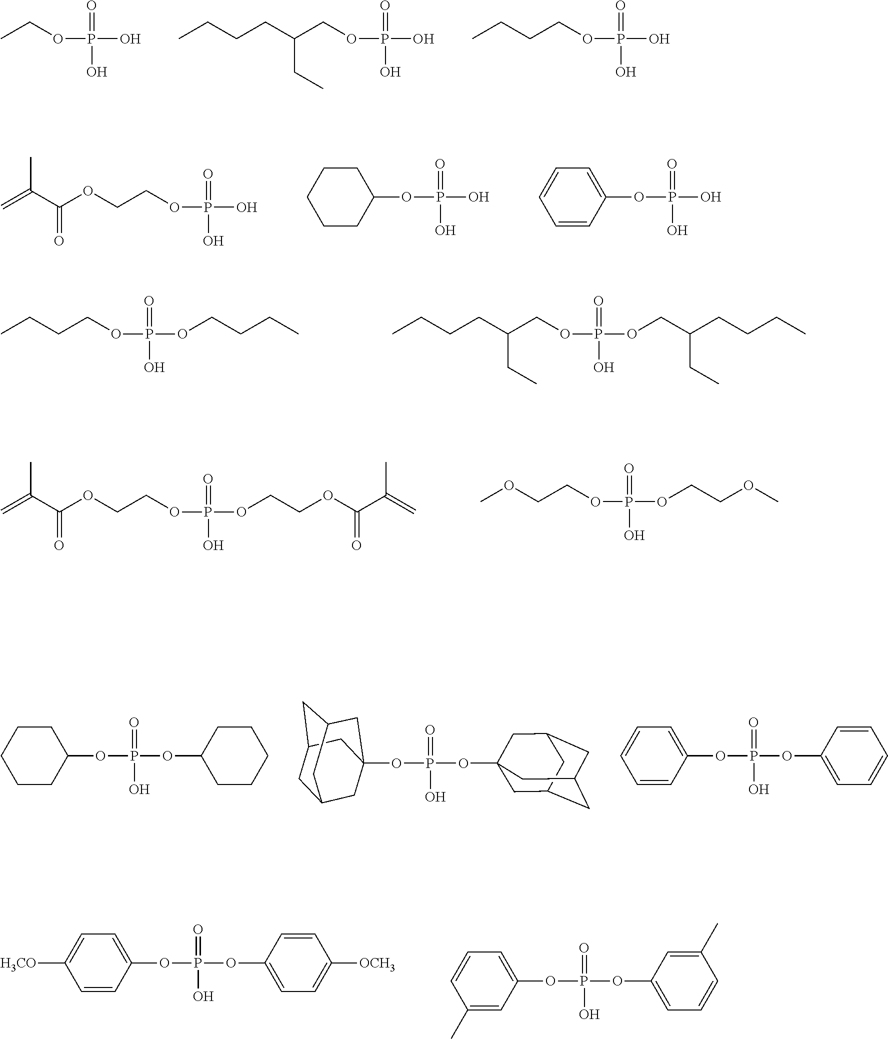

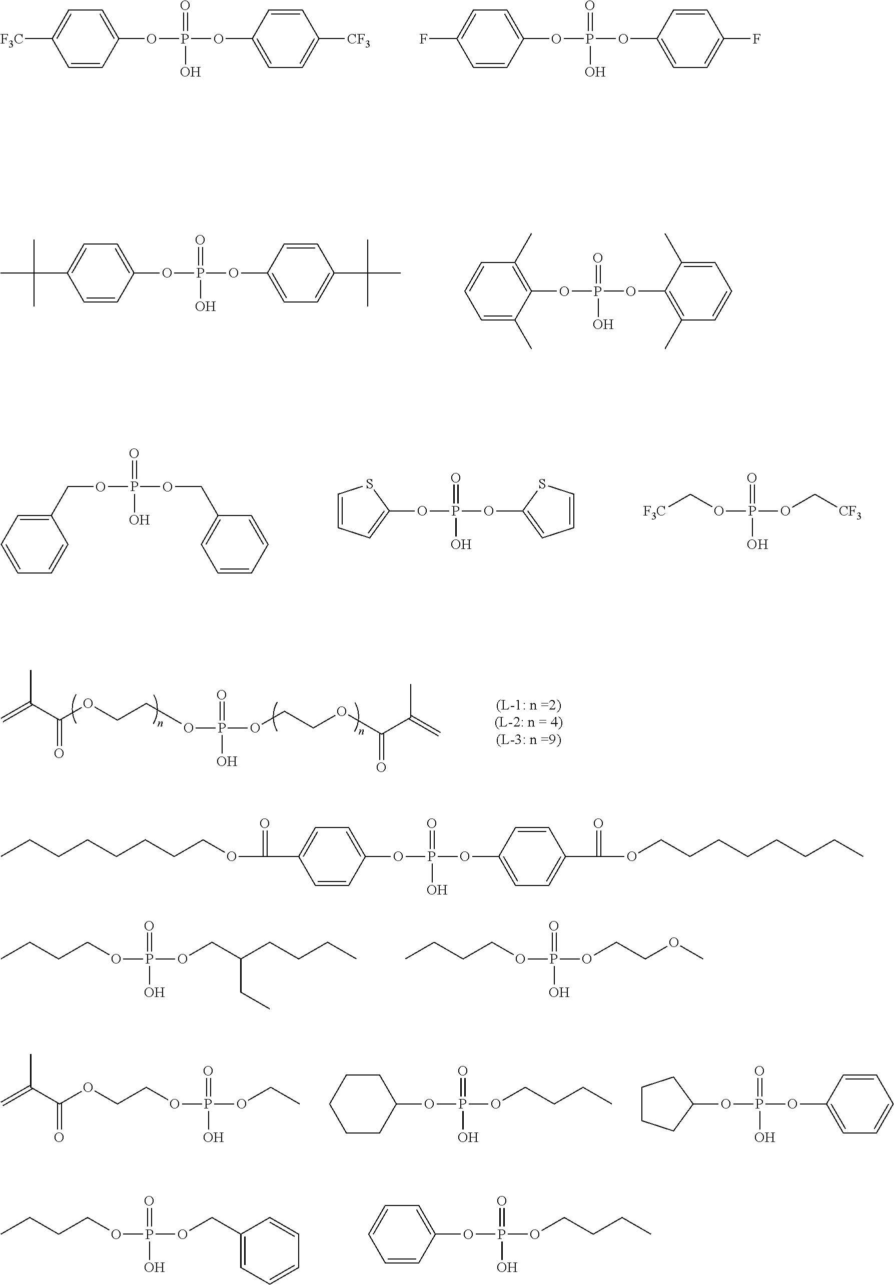

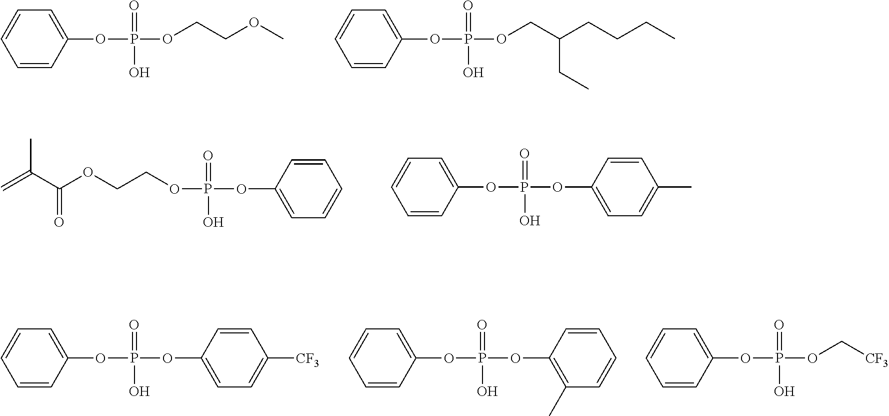

### <<<Phosphonate Ester-Copper Complexes>>>

Phosphate ester-copper complexes used in the present invention may consist of copper as a central metal and a phosphonate ester compound as a ligand.

The phosphonate ester compound forming the ligand L is more preferably a compound represented by formula (E) below:

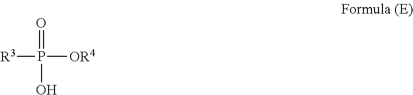

In formula (E), R³ and R⁴ each independently represent a monovalent organic group.

The compound represented by formula (E) and salts thereof act as a ligand coordinated to copper.

In formula (3), R³ and R⁴ each independently represent a monovalent organic group. Specific monovalent organic groups include, but not specifically limited to, straight-chain, branched or cyclic alkyl group, alkenyl group, aryl group, and heteroaryl group. These groups here may be linked via a divalent linking group (e.g., alkylene group, cycloalkylene group, arylene group, heteroarylene group, —O—, —S—, —CO—, —COO—, —OCO—, —SO₂—, —NR— (wherein R represents a hydrogen atom or an alkyl group) or the like). Further, the monovalent organic group may be substituted.

The straight-chain or branched alkyl group is preferably an alkyl group containing 1 to 20 carbon atoms.

The cyclic alkyl group, aryl group and heteroaryl group are as defined for the cyclic alkyl group, aryl group and heteroaryl group in formula (C) above, and also cover the same preferred ranges.

The alkenyl group is preferably an alkenyl group containing 2 to 10 carbon atoms. Specifically, examples include vinyl, 1-propenyl, 1-butenyl and the like.

Straight-chain, branched or cyclic alkylene group, arylene group or heteroarylene group used as divalent linking groups include those mentioned in formula (C) above.

Further, substituents by which the monovalent organic group may be substituted include those mentioned in formula (C) above.

Alternatively, phosphonate ester-copper complexes used in the present invention contain a structure represented by formula (F) below:

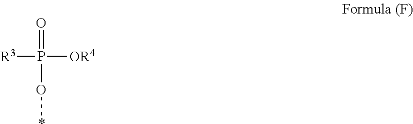

In formula (F), R³ and R⁴ each independently represent a monovalent organic group. The asterisk (*) indicates the point of attachment to copper to form a coordinate bond.

In formula (F) above, R³ and R⁴ have the same meanings as defined for R³ and R⁴ in formula (E) above, and also cover the same preferred ranges.

The phosphonate ester compound represented by formula (E) above preferably has a molecular weight of 200 to 1000, more preferably 250 to 750, even more preferably 300 to 500.

Specific examples of phosphonate ester compounds are shown below.

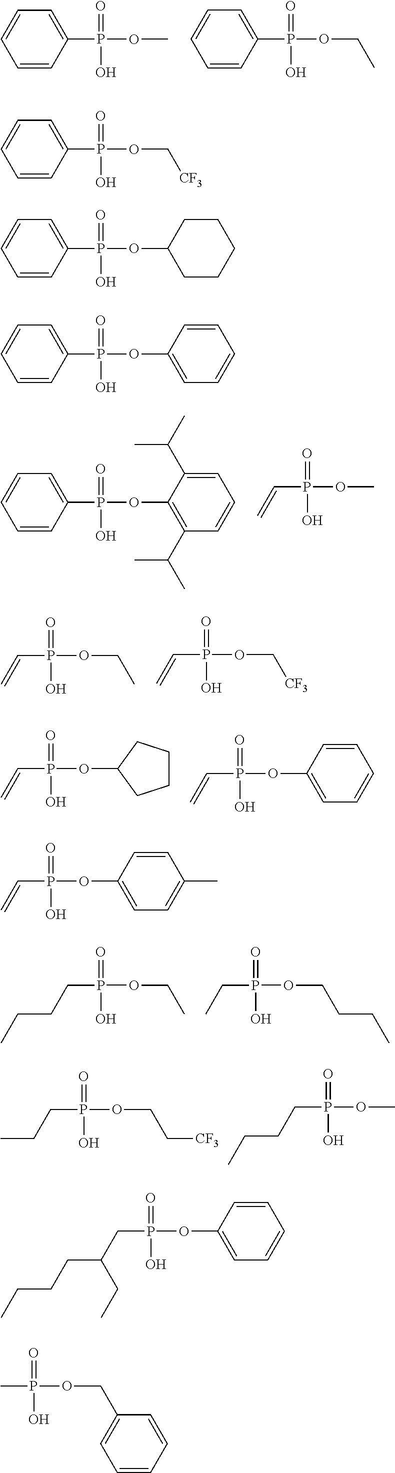

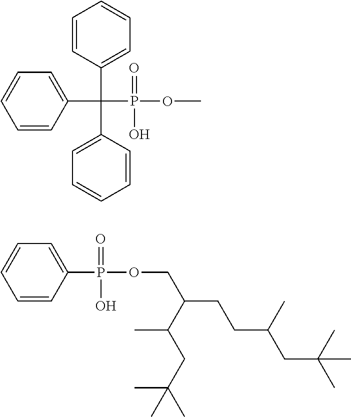

### <<<Substituted Phosphinic Acid-Copper Complexes>>>

Substituted phosphinic acid-copper complexes used in the present invention consist of copper as a central metal and a substituted phosphinic acid compound as a ligand. The substituted phosphinic acid compound forming the ligand L is more preferably a compound represented by formula (G) below:

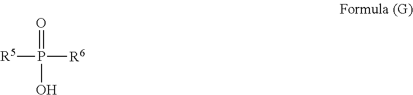

In formula (G), R⁵ and R⁶ each independently represent a monovalent organic group.

The compound represented by formula (G) and salts thereof act as a ligand coordinated to copper.

In formula (G), R⁵ and R⁶ each independently represent a monovalent organic group. Specific monovalent organic groups include, but not specifically limited to, straight-chain, branched or cyclic alkyl group, aryl group and heteroaryl group.

These groups here may be linked via a divalent linking group (e.g., alkylene group, cycloalkylene group, arylene group, heteroarylene, —O—, —S—, —CO—, —COO—, —OCO—, —SO₂—, —NR— (wherein R represents a hydrogen atom or an alkyl group) and the like). Further, the monovalent organic group may be substituted.

The straight-chain or branched alkyl group is preferably an alkyl group containing 1 to 20 carbon atoms. The cyclic alkyl group, aryl group and heteroaryl group are as defined for the cyclic alkyl group, aryl group and heteroaryl group in formula (C) above, and also cover the same preferred ranges. Straight-chain, branched or cyclic alkylene group, arylene group or heteroarylene group used as divalent linking groups include those mentioned in formula (C) above.

Further, substituents by which the monovalent organic group may be substituted include those mentioned in formula (C) above.

Alternatively, substituted phosphinic acid-copper complexes used in the present invention contain a structure represented by formula (H) below:

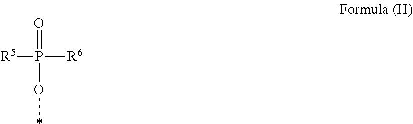

In formula (H), R⁵ and R⁶ each independently represent a monovalent organic group. The asterisk (*) indicates the point of attachment to copper to form a coordinate bond.

In formula (H) above, R⁵ and R⁶ have the same meanings as defined for R⁵ and R⁶ in formula (G) above, and also cover the same preferred ranges.

The substituted phosphinic acid compound represented by formula (G) above preferably has a molecular weight of 50 to 750, more preferably 50 to 500, even more preferably 80 to 300.

Specific examples of substituted phosphinic acid compounds are shown below.

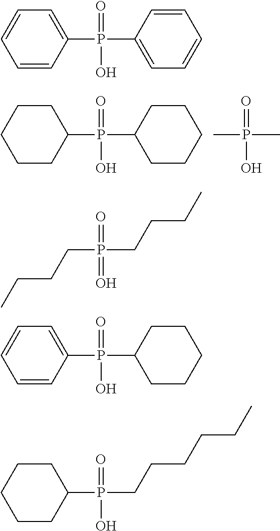

The phosphorus-containing copper complexes used in the present invention can be obtained by reacting a copper component with a phosphorus-containing compound forming a ligand (e.g., a phosphate ester, aphosphonate ester, a substituted phosphinic acid or the like) or a salt thereof.

Copper or a copper-containing compound can be used as the copper component. A copper-containing compound that can be used is, for example, a copper oxide or a copper salt. Preferably, the copper salt is a salt of monovalent or divalent copper, more preferably divalent copper. More preferably, the copper salt is copper acetate, copper chloride, copper formate, copper stearate, copper benzoate, copper ethylacetoacetate, copper pyrophosphate, copper naphthenate, copper citrate, copper nitrate, copper sulfate, copper carbonate, copper chlorate, copper (meth)acrylate, or copper perchlorate, even more preferably copper acetate, copper chloride, copper sulfate, copper benzoate, or copper (meth)acrylate.

The phosphorus-containing compound used in the present invention can be synthesized by, for example, referring to known methods.

For example, the phosphate ester compound can be obtained by reacting 2-hydroxyethyl methacrylate, phenyl phosphate ester, and 1,3,5-triisopropylsulfonyl chloride in pyridine as a solvent.

Salts of phosphorus-containing compounds used in the present invention preferably include, for example, metal salts such as sodium salts, potassium salts, magnesium salts, calcium salts, borate salts and the like.

The reactant ratio of the copper component to the phosphorus-containing compound or a salt thereof as described above is preferably 1:1.5 to 1:4 expressed in a molar ratio.

Further, the reaction conditions under which the copper component is reacted with the phosphorus-containing compound or a salt thereof as described above preferably involve, for example, 20 to 50° C. for 0.5 hours or more.

The phosphorus-containing copper complexes of the present invention have a maximum absorption wavelength (λₘₐₓ) at 700 to 2500 nm, preferably 700 to 2500 nm, more preferably 720 to 890 nm, even more preferably 730 to 880 nm. The maximum absorption wavelength can be measured by using, for example, Cary 5000 UV-Vis-NIR (a spectrophotometer from Agilent Technologies Inc.).

Further, the phosphorus-containing copper complexes of the present invention preferably have a gram absorptivity of 0.04 or more (g/mL), more preferably 0.06 or more (g/mL), even more preferably 0.08 or more (g/mL).

The gram absorptivity can be calculated by using, for example, Cary 5000 UV-Vis-NIR (a spectrophotometer from Agilent Technologies Inc.).

### <<Sulfonic Acid-Copper Complexes>>

Sulfonic acid-copper complexes can be found in, for example, 0031 to 0035 of Japanese Patent Application No. 2013-030488, the disclosure of which is incorporated herein by reference.

The sulfonic acid-copper complexes used in the present invention consist of copper as a central metal and a sulfonic acid compound as a ligand.

The sulfonic acid compound as a ligand is more preferably a compound represented by formula (I-0) below:

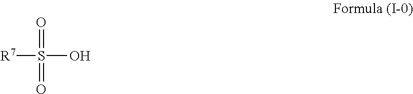

In formula (I-0), R⁷ represents a monovalent organic group.

The sulfonic acid represented by formula (I-0) and salts thereof act as a ligand coordinated to copper.

Specific monovalent organic groups include, but not specifically limited to, straight-chain, branched or cyclic alkyl group, alkenyl group and aryl group. These groups here may be linked via a divalent linking group (e.g., alkylene group, cycloalkylene group, arylene group, —O—, —S—, —CO—, —COO—, —OCO—, —SO₂—, —NR— (wherein R represents a hydrogen atom or an alkyl group) and the like). Further, the monovalent organic group may be substituted.

Preferably, the straight-chain or branched alkyl group is an alkyl group containing 1 to 20 carbon atoms, more preferably an alkyl group containing 1 to 12 carbon atoms, even more preferably an alkyl group containing 1 to 8 carbon atoms.

The cyclic alkyl group may be monocyclic or polycyclic. Preferably, the cyclic alkyl group is a cycloalkyl group containing 3 to 20 carbon atoms, more preferably a cycloalkyl group containing 4 to 10 carbon atoms, even more preferably a cycloalkyl group containing 6 to 10 carbon atoms. Preferably, the alkenyl group is an alkenyl group containing 2 to 10 carbon atoms, more preferably an alkenyl group containing 2 to 8 carbon atoms, even more preferably an alkenyl group containing 2 to 4 carbon atoms.

Preferably, the aryl group is an aryl group containing 6 to 18 carbon atoms, more preferably an aryl group containing 6 to 14 carbon atoms, even more preferably an aryl group containing 6 to 10 carbon atoms.

Alkylene group, cycloalkylene group or arylene group used as divalent linking groups include divalent linking groups derived by removing one hydrogen atom from the alkyl group, cycloalkyl group or aryl group described above.

Examples of substituents by which the monovalent organic group may be substituted include alkyl groups, polymerizable groups (e.g., vinyl group, (meth)acryloyl group, epoxy group, oxetane group and the like), halogen atoms, carboxyl groups, carboxylate ester groups (e.g., —CO₂CH₃ and the like), hydroxyl, amide groups, haloalkyl groups (e.g., fluoroalkyl, chloroalkyl) and the like.

Alternatively, sulfonic acid-copper complexes of the present invention contain a structure represented by formula (J) below:

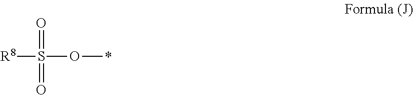

In formula (J), R⁸ represents a monovalent organic group. The asterisk (*) indicates the point of attachment to copper to form a coordinate bond.

In formula (J) above, R⁸ has the same meaning as defined for R⁸ in formula (I-0) above, and also covers the same preferred ranges.

The sulfonic acid compound represented by formula (J) above preferably has a molecular weight of 80 to 750, more preferably 80 to 600, even more preferably 80 to 450.

Specific examples of sulfonic acid compounds represented by formula (I-0) or formula (J) are shown below, but the present invention is not limited to these examples.

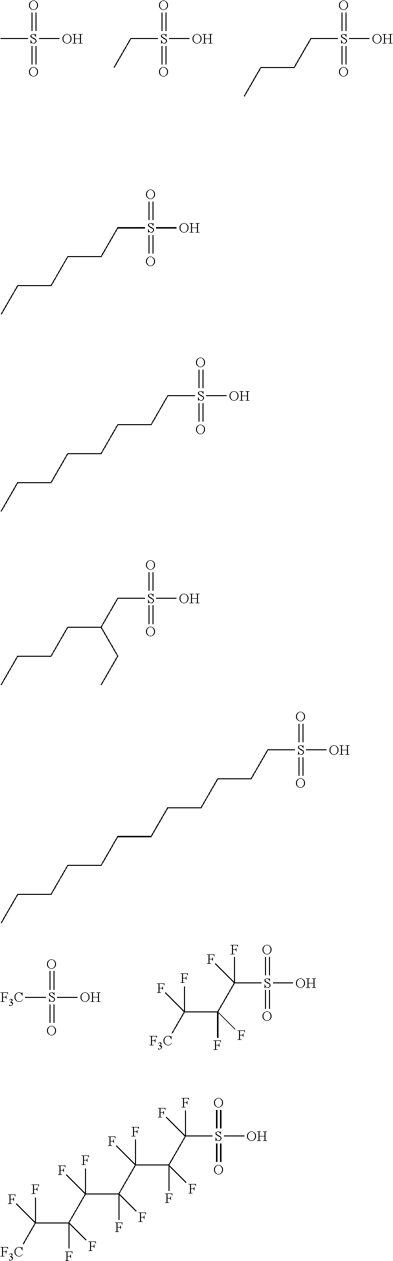

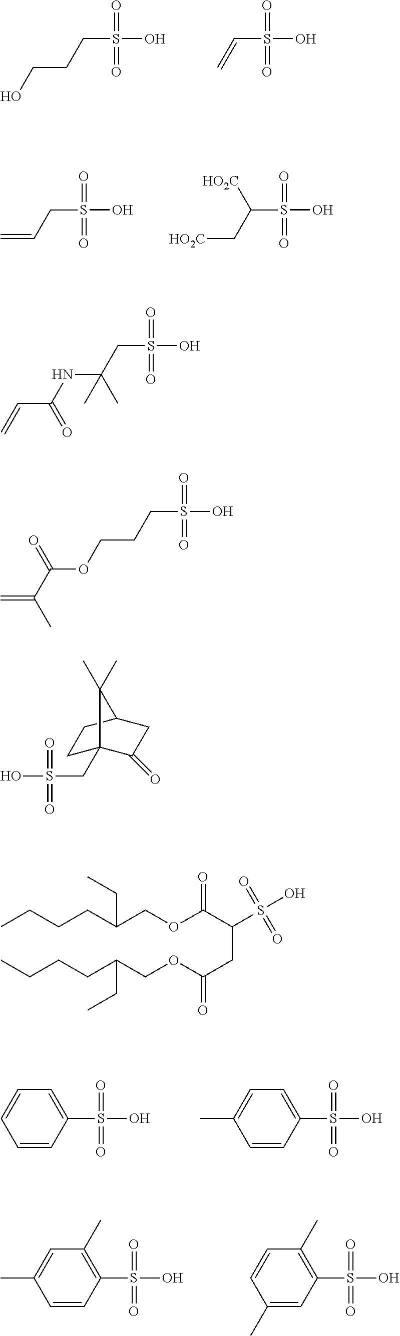

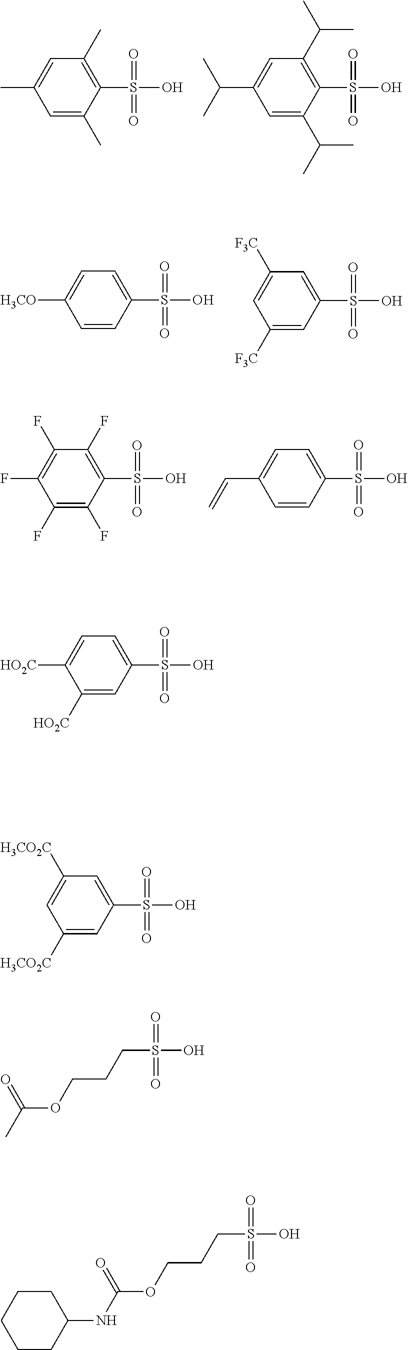

The sulfonic acid-copper complexes used in the present invention can be obtained by reacting a copper component with a sulfonic acid compound forming a ligand or a salt thereof. The copper component is as defined for the phosphorus-containing copper complexes described above, and also covers the same preferred ranges.

The sulfonic acid compound used in the present invention may be a commercially available sulfonic acid or can be synthesized by referring to known methods.

Salts of sulfonic acid compounds used in the present invention preferably include, for example, metal salts such as sodium salts, potassium salts and the like.

The reactant ratio of the copper component to the sulfonic acid compound or a salt thereof as described above is preferably 1:1.5 to 1:4 expressed in a molar ratio. In this case, one or more than one sulfonic acid compound or salt thereof may be used. Further, the reaction conditions under which the copper component is reacted with the sulfonic acid compound or a salt thereof as described above preferably involve, for example, 20 to 50° C. for 0.5 hours or more.

The maximum absorption wavelength and the gram absorptivity of the sulfonic acid-copper complexes of the present invention are as defined for the phosphorus-containing copper complexes described above, and also cover the same preferred ranges.

### <<Other Copper Compounds>>

Copper compounds that may be used in the present invention other than those described above include copper compounds containing a carboxylate ester as a ligand. However, it should be understood that the present invention is not limited to those compounds. For example, a compound represented by formula (K) below is preferred.

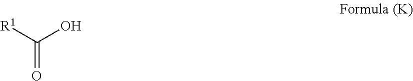

In formula (K), R₁ represents a monovalent organic group. In formula (K), R₁ represents a monovalent organic group. The monovalent organic group is as defined for, but not specifically limited to, the monovalent organic group in formula (C) described above, for example.

The copper in the copper complexes of the present invention is typically divalent copper, and such complexes can be obtained by, for example, mixing/reacting or otherwise treating a copper component (copper or a copper-containing compound) with a compound forming a ligand or a salt thereof as described above. It can be said that if a copper component and a compound structure forming a ligand could be detected in a composition of the present invention, a copper complex has been formed in the composition of the present invention. For example, a method for detecting copper and a phosphate ester compound in a composition of the present invention includes ICP Optical Emission Spectrometry, by which copper and a phosphate ester compound can be detected.

The amount of the infrared absorbing material contained in the compositions of the present invention can be controlled as appropriate, but it is preferably 0.01 to 50% by mass, more preferably 0.1 to 30% by mass, even more preferably 0.5 to 15% by mass based on the total solids of the compositions. When it is in the ranges indicated above, infrared absorbing ability and invisibility can be provided at the same time.

In cases where the infrared absorbing dye described above is used as an infrared absorbing material, for example, the amount of the infrared absorbing material contained is preferably 0.01 to 50% by mass, more preferably 0.1 to 30% by mass, even more preferably 0.5 to 15% by mass based on the total solids of the compositions of the present invention.

In alternative cases where the copper compound described above is used as an infrared absorbing material, for example, the amount of the infrared absorbing material contained is preferably 0.01 to 50% by mass, more preferably 0.1 to 30% by mass, even more preferably 1 to 15% by mass based on the total solids of the compositions of the present invention.

### <Polymerizable Compound>

The compositions of the present invention comprise a polymerizable compound containing a partial structure represented by formula (1) above. The polymerizable compound containing a partial structure represented by formula (1) exhibits water-solubility so that it dissolves well in water and water-soluble organic solvents such as alcohols.

The partial structure represented by formula (1) above may be a part of a polymerizable group. For example, such a case is where the polymerizable group is (meth)acrylamide group.

Preferably, the polymerizable compound used in the present invention contains two or more partial structures represented by formula (1) above, more preferably three or more partial structures represented by formula (1) above, even more preferably four or more partial structures represented by formula (1) above. On the other hand, the upper limit of the number of partial structures represented by formula (1) above contained in the polymerizable compound used in the present invention is not specifically limited, but preferably eight or less, more preferably six or less, especially preferably four.

Further, the polymerizable compound containing a partial structure represented by formula (1) above preferably contains two or more polymerizable functional groups. Polymerizable functional groups include, for example, polymerizable groups containing a carbon-carbon double bond, specifically (meth)acrylamide group, vinyl group, (meth)acryloyloxy group, (meth) acryloyl group, epoxy group, aziridinyl group and the like. Especially, the polymerizable compound containing a partial structure represented by formula (1) above preferably contains two or more (meth)acrylamide groups, more preferably three or more (meth)acrylamide groups, even more preferably four (meth)acrylamide groups.

When the polymerizable compound containing a partial structure represented by formula (1) above is a compound containing four (meth)acrylamide groups, the compound is preferably asymmetric.

Preferably, the polymerizable compound containing a partial structure represented by formula (1) above is a polymerizable compound containing two or more partial structures represented by formula (1-1) below:

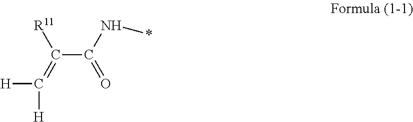

In formula (1-1), R¹¹ represents a hydrogen atom or methyl. The asterisk (*) indicates the point of attachment to another atom.

Especially, the polymerizable compound containing a partial structure represented by formula (1) above preferably contains two or more partial structures represented by formula (1-1) above, more preferably three or more partial structures represented by formula (1-1) above, even more preferably four partial structures represented by formula (1-1) above.

The polymerizable compound containing a partial structure represented by formula (1) above is preferably represented by formula (1-2) below:

A¹—C—(L¹-A¹)₃ Formula (1-2)

In formula (1-2), A¹ each independently represents a partial structure represented by formula (1-1) below, and L represents a divalent linking group.

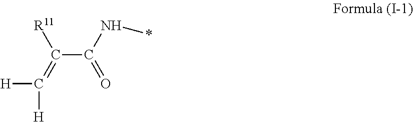

In formula (1-1), R¹¹ represents a hydrogen atom or methyl. The asterisk (*) indicates the point of attachment to another atom.

In formula (1-2), A¹ represents a partial structures represented by formula (1-1) above.

In formula (1-2), L¹ represents a divalent linking group. Preferably, the divalent linking group is a group selected from alkylene group, —O—, —S—, —CO—, —SO₂—, —NRa— (wherein Ra represents an alkyl group containing 1 to 5 carbon atoms or a hydrogen atom, preferably methyl or a hydrogen atom), alkenylene group, alkynylene group and arylene group, or a combination of two or more of these groups. More preferably, it is a divalent linking group consisting of an alkylene group or a combination of an alkylene group and —O—. Preferably, the chain moiety of L contains 1 to 20 atoms. The chain here refers to the longest chain of atoms attached to A¹ in formula (1-2) above. For example, the chain in a —CH₂—CH₂— (meth)acrylamide group contains two carbon atoms.

The alkylene group, alkenylene group and alkynylene group may be straight-chain, branched and cyclic, but preferably straight-chain or branched, more preferably straight-chain.

Preferably, the polymerizable compound containing a partial structure represented by formula (1) above is represented by formula (1-3) below:

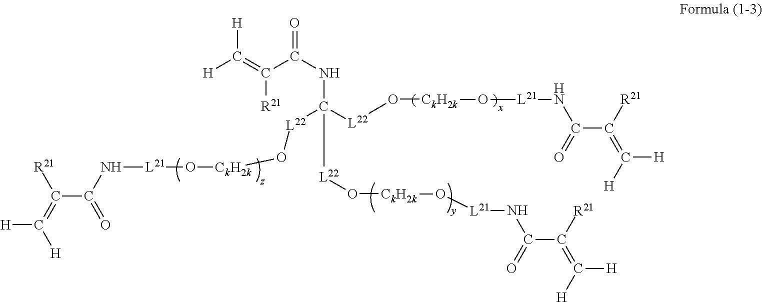

In formula (1-3), R²¹ each independently represents a hydrogen atom or methyl group. L²¹ represents a straight-chain or branched alkylene group containing 2 to 4 carbon atoms, provided that L²¹ does not adopt a structure in which an oxygen atom and a nitrogen atom at both ends of L²¹ are attached to the same carbon atom of L²¹. L²² represents a divalent linking group. k represents 2 or 3. x, y and z each independently represent an integer of 0 to 6, provided that x+y+z satisfies 0 to 18.

The polymerizable compound represented by formula (1-3) used in the present invention contains four (meth)acrylamide groups as polymerizable groups in the molecule so that it has high polymerization performance and curability. For example, it is polymerized to exhibit curability when irradiated (exposed) with an active energy beam such as α-rays, γ-rays, X-rays, Ultraviolet rays, visible rays, infrared rays or electron beams or energy such as heat. Further, the polymerizable compound represented by formula (1-3) is water-soluble so that it dissolves well in water and water-soluble organic solvents such as alcohols.

R²¹ each independently represents a hydrogen atom or methyl group. Multiple R²¹ groups may be identical to or different from each other. Preferably, R²¹ represents a hydrogen atom.

L²¹ represents a straight-chain or branched alkylene group containing 2 to 4 carbon atoms. Multiple L²¹ groups may be identical to or different from each other. Preferably, the alkylene group represented by L²¹ contains 3 or 4 carbon atoms, more preferably 3 carbon atoms, and it is especially preferably a straight-chain alkylene group containing 3 carbon atoms. The alkylene group represented by L²¹ may further be substituted by substituents such as aryl group, alkoxy group and the like.

However, L²¹ does not adopt a structure in which an oxygen atom and a nitrogen atom at both ends of L²¹ are attached to the same carbon atom of L²¹. L²¹ is a straight-chain or branched alkylene group that links an oxygen atom to the nitrogen atom of a (meth)acrylamide group, and if the alkylene group has a branched structure, it may adopt a —O—C—N— structure (a hemiaminal structure) in which an oxygen atom and the nitrogen atom of a (meth)acrylamide group at both ends are attached to the same carbon atom in the alkylene group. However, any compounds containing such a structure are not included in the polymerizable compound represented by formula (1-3) used in the present invention. Molecules containing a —O—C—N— structure are likely to decompose at the carbon atom. Especially, such compounds are likely to decompose during storage and to be promoted to decompose in the presence of water or moisture, thereby affecting storage stability of curable compositions containing them.

The divalent linking group represented by L²² is an alkylene group, arylene group or divalent heterocyclic group, or a combination thereof or the like, preferably an alkylene group. It should be noted that when the divalent linking group contains an alkylene group, this alkylene group may further contain at least one group selected from —O—, —S— and —N(Ra)— wherein Ra represents a hydrogen atom or an alkyl group containing 1 to 4 carbon atoms.

In this connection, the expression “an alkylene group containing —O—” means that alkylene groups in a linking chain of a linking group are linked via the hetero atom as in -alkylene-O-alkylene-, for example.

Specific examples of alkylene groups containing —O— include —C₂H₄—O—C₂H₄—, —C₃H₆—O—C₃H₆— and the like.

When L²² contains an alkylene group, the alkylene group includes methylene, ethylene, propylene, butylene, pentylene, hexylene, heptylene, octylene, nonylene or the like. Preferably, the alkylene group in L² contains 1 to 6 carbon atoms, more preferably 1 to 3 carbon atoms, especially preferably 1 carbon atom. Further, this alkylene group may further be substituted by substituents such as aryl group, alkoxy group and the like.

When L²² contains an arylene group, the arylene group includes phenylene, naphthylene or the like. The arylene group preferably contains 6 to 14 carbon atoms, more preferably 6 to 10 carbon atoms, especially preferably 6 carbon atoms. This arylene group may further be substituted by substituents such as aryl, alkoxy and the like.

When L²² contains a divalent heterocyclic group, this heterocycle is preferably a 5- or 6-membered ring and may be a fused ring system. Further, it may be an aromatic heterocyclic ring or a non-aromatic heterocyclic ring. Heterocycles of divalent heterocyclic groups include pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isoxazole, benzisoxazole, pyrrolidine, piperidine, piperazine, imidazolidine, thiazoline and the like. Among others, preferred are aromatic heterocyclic rings preferably including pyridine, pyrazine, pyrimidine, pyridazine, triazine, pyrazole, imidazole, benzimidazole, triazole, thiazole, benzothiazole, isothiazole, benzisothiazole, and thiadiazole.

The two positions available for bonding on the heterocycles of divalent heterocyclic groups are not specifically limited, e.g., pyridine may be substituted at any two of the 2-, 3-, and 4-positions.

Further, the heterocycles of divalent heterocyclic groups may further be substituted by substituents such as alkyl group, aryl group, alkoxy group and the like.

k represents 2 or 3 and multiple k groups may be identical to or different from each other. Further, CₖH₂ₖ may be a straight-chain structure or a branched structure.

x, y and z each independently represent an integer of 0 to 6, preferably an integer of 0 to 5, more preferably an integer of 0 to 3. x+y+z satisfies 0 to 18, preferably 0 to 15, more preferably 0 to 9.

Polymerizable compounds containing a partial structure represented by formula (1) above can be found in, for example, paragraphs 0027 to 0034 of JPA2013-18846, the disclosure of which is incorporated herein by reference.

The polymerizable compound containing a partial structure represented by formula (1) above may be a monomer or a polymer, but it is preferably a monomer. The polymerizable compound containing a partial structure represented by formula (1) above preferably has a molecular weight of 300 to 1500, more preferably 500 to 1000.

Preferably, the compositions of the present invention comprise the polymerizable compound containing a partial structure represented by formula (1) above in an amount of 5 to 90% by mass, more preferably 10 to 80% by mass, even more preferably 30 to 70% by mass based on the total solids.

Only one or a combination of two or more of polymerizable compounds containing a partial structure represented by formula (1) above may be used.

### <Surfactants>

The compositions of the present invention may comprise a surfactant. Only one or a combination of two or more of surfactants may be used. The amount of the surfactant to be added is preferably 0.0001 to 2% by mass, more preferably 0.005 to 1.0% by mass of the compositions of the present invention. Surfactants that can be used include various surfactants such as fluorosurfactant, nonionic surfactants, cationic surfactants, anionic surfactants, silicone surfactants and the like.

Especially when the compositions of the present invention contain at least one of fluorosurfactants and silicone surfactants, the liquid properties (especially flowability) of the coating solution prepared therefrom are further improved so that the uniformity of the coating thickness and coating consumption reduction can be further improved.

Fluorosurfactants include, for example, Megaface F171, F172, F173, F176, F177, F141, F142, F143, F144, R30, F437, F479, F482, F554, F780, F781, and R08 (all from DIC Corporation); Fluorad FC430, FC431, and FC171 (all from Sumitomo 3M Limited); SURFLON S-382, S-141, S-145, SC-101, SC-103, SC-104, SC-105, SC1068, SC-381, SC-383, S393, and KH-40 (all from ASAHI GLASS CO., LTD.); Eftop EF301, EF303, EF351, and EF352 (all from JEMCO, Inc.); PF636, PF656, PF6320, PF6520, and PF7002 (from OMNOVA); and the like.

Nonionic surfactants specifically include the nonionic surfactants described in paragraph 0553 of JPA2012-208494 (or [0679] of the corresponding US Patent Application Publication No. 2012/0235099), the disclosure of which is incorporated herein by reference.

Cationic surfactants specifically include the cationic surfactants described in paragraph 0554 of JPA2012-208494 (or [0680] of the corresponding US Patent Application Publication No. 2012/0235099), the disclosure of which is incorporated herein by reference.

Anionic surfactants specifically include W004, W005 and W017 (from Yusho Co., Ltd.) and the like.

### <Polymerization Initiators>

The compositions of the present invention may comprise a polymerization initiator. Only one or more than one polymerization initiator may be contained, and when two or more initiators are contained, the total amount should be in the ranges indicated above. The amount of the polymerization initiator to be added is preferably 0.01 to 30% by mass, more preferably 0.1 to 25% by mass, especially preferably 0.1 to 20% by mass based on the total solids of the compositions of the present invention.

The polymerization initiator is not specifically limited so far as it has the ability to initiate the polymerization of the polymerizable compound in the presence of either light or heat or both, and can be appropriately selected depending on the purposes, but it is preferably a photoinitiator. Initiators that initiate polymerization in the presence of light preferably have photosensitivity to the light from the ultraviolet to visible regions.

On the other hand, polymerization initiators that initiate polymerization in the presence of heat preferably decompose at 150 to 250° C.

Polymerization initiators that can be used in the present invention are preferably compounds containing at least an aromatic group, and such compounds include, for example, acyl phosphine compounds, acetophenone compounds, α-aminoketone compounds, benzophenone compounds, benzoin ether compounds, ketal derivative compounds, thioxanthone compounds, oxime compounds, hexaaryl biimidazole compounds, trihalomethyl compounds, azo compounds, organic peroxides; onium salt compounds such as diazonium compounds, iodonium compounds, sulfonium compounds, azinium compounds and metallocene compounds; organoboron salt compounds, disulfone compounds and the like.

To improve sensitivity, oxime compounds, acetophenone compounds, α-aminoketone compounds, trihalomethyl compounds, hexaaryl biimidazole compounds, and thiol compounds are preferred.

Oxime compounds that can be used include commercial products such as IRGACURE-OXE01 (from BASF) and IRGACURE-OXE02 (from BASF).

Acetophenone initiators that can be used include commercial products such as IRGACURE-907, IRGACURE-369, IRGACURE-379, and IRGACURE 2959 (all brand names from BASF Japan Ltd.).

Acyl phosphine initiators that can be used include commercial products such as IRGACURE-819 and DAROCUR-TPO (both brand names from BASF Japan Ltd.).

### <Solvents>

The compositions of the present invention may comprise a solvent. The solvent used in the present invention is not specifically limited, and can be appropriately selected depending on the purposes from those in which various components of the compositions of the present invention can be homogeneously dissolved or dispersed. Suitable solvents include water, ketones, esters, aromatic hydrocarbons, halogenated hydrocarbons, and dimethylformamide, dimethylacetamide, dimethyl sulfoxide, sulfolane and the like. These solvents may be used alone or as a mixture of two or more of them.

One or more than solvent may be used. The solvent is preferably contained in an amount of 25 to 90% by mass, more preferably 35 to 85% by mass of the compositions of the present invention. The compositions of the present invention also include embodiments comprising water or an aqueous solvent as a solvent. Even if the compositions of the present invention comprise water or an aqueous solvent, they can be dissolved well because the polymerizable compound containing a partial structure represented by formula (1) above exhibits water solubility. Aqueous solvents include alcohols and the like. Water or aqueous solvents may be used alone or as a mixture of two or more of them.

When the compositions of the present invention contain water or an aqueous solvent as a solvent, the amount of the solvent contained is preferably 10 to 45% by mass, more preferably 10 to 25% by mass of the compositions of the present invention.

Solvents used in the present invention include, for example, those described in paragraph 0497 of JPA2012-208494 (or [0609] of the corresponding US Patent Application Publication No. 2012/0235099), the disclosure of which is incorporated herein by reference.

### <Curable Compounds>

In addition to the polymerizable compound containing a partial structure represented by formula (1) above, the compositions of the present invention may further comprise a curable compound. For example, polyfunctional (meth)acrylate compounds are included. Curable compounds that can be used in the present invention can be found in, for example, paragraphs 0466 to 0495 of JPA2012-208494 (or [0571] to [0606] of the corresponding US Patent Application Publication No. 2012/0235099), the disclosure of which is incorporated herein by reference.

The amount of curable compounds other than those containing a structure represented by formula (1) in the compositions of the present invention is preferably 0 to 80% by mass, more preferably 0 to 50% by mass, especially preferably 0 to 10% by mass based on the total solids excluding the solvent. Only one or more than one polymerizable compound may be used, and when two or more such compounds are used, the total amount should be in the ranges indicated above.

### <Binder Polymers>

In the present invention, a binder polymer may be further contained in addition to the polymerizable compound containing a partial structure represented by formula (1) above as appropriate to improve film properties or for other purposes. A binder polymer preferably used is an alkali-soluble resin. The presence of an alkali-soluble resin is effective for improving heat resistance or other properties and for strictly optimizing coatability.

Alkali-soluble resins can be found in paragraphs 0558 to 0571 of JPA2012-208494 (or [0685] to [0700] of the corresponding US Patent Application Publication No. 2012/0235099) et seq., the disclosure of which is incorporated herein by reference. The amount of the binder polymer contained in the present invention is preferably 0 to 80% by mass, more preferably 0 to 50% by mass, even more preferably 0 to 30% by mass based on the total solids of the compositions.

### <Other Components>

In addition to the essential components and preferred additives described above, the compositions of the present invention may employ other components selected as appropriate depending on the purposes so far as the advantages of the present invention are not adversely affected.

Other components that can be concomitantly used include, for example, dispersants, sensitizers, crosslinking agents, curing promoters, fillers, heat curing promoters, thermal polymerization inhibitors, plasticizers and the like, as well as substrate surface adhesion promoters and other auxiliaries (e.g., conductive particles, bulking agents, defoamers, flame retardants, levelling agents, release promoters, antioxidants, perfumes, surface tension modifiers, chain transfer agents and the like).

Various properties such as stability and film properties of intended infrared absorbing filters can be optimized by adding these components as appropriate.

These components can be found in, for example, paragraph numbers 0183 to 0260 of JPA2012-003225, paragraph numbers 0101 to 0102 of JPA2008-250074, paragraph numbers 0103 to 0104 of JPA2008-250074, paragraph numbers 0107 to 0109 of JPA2008-250074 and the like, the disclosures of which are incorporated herein by reference.

### <Processes for Manufacturing Infrared Cut Filters>

The compositions of the present invention can be liquid so that infrared cut filters can be readily manufactured by, for example, directly coating the compositions of the present invention and drying them.

A process for manufacturing an infrared cut filter of the present invention comprises coating an infrared absorbing composition as described above to form an infrared absorption pattern. The infrared absorbing composition is preferably coated as a dispersion in water or an aqueous solvent.

An infrared absorption pattern can be formed by, for example, coating a resist solution on a substrate, exposing the coated substrate through a mask having a predetermined pattern, and developing it with a developer, whereby a negative or positive infrared absorption pattern can be formed. Such a method for forming an infrared absorption pattern can be found in, for example, paragraphs 0140 to 0145 of JPA2011-68731 (or [0204] to [0216] of the corresponding US Patent Application Publication No. 2011/0070407), the disclosure of which is incorporated herein by reference.

Alternatively, an infrared absorption pattern can be formed by forming a cured film using an infrared absorbing composition as described above, forming a photoresist layer on the cured film, removing this photoresist layer in a pattern to form a resist pattern, dry-etching the film using this resist pattern as an etching mask, and removing the resist pattern remaining after etching. Such a method for forming an infrared absorption pattern can be found in, for example, JPA2008-241744, the disclosure of which is incorporated herein by reference.

Further, the present invention also relates to a process for manufacturing an infrared cut filter, comprising forming a layer by applying (preferably coating or printing, more preferably coating by an applicator) an infrared absorbing composition of the present invention, and drying it. The thickness of the layer, the laminate structure and the like can be appropriately selected depending on the purposes.

The substrate may be a transparent substrate made of glass or the like, or a solid-state image sensor board, or another substrate provided on the light-capturing side of a solid-state image sensor board (e.g., the glass substrate 30 described later), or a layer provided on the light-capturing side of a solid-state image sensor board such as a planarization layer.

The infrared absorbing composition (coating solution) can be applied on the substrate by using, for example, a spin coater, a slot die/spin coater, a slot die coater, screen printing, an applicator or the like.

Further, the conditions under which the coating layer is dried depend on the types and the proportions of various components and solvents and the like, but typically involve a temperature of 60° C. to 150° C. for about 30 seconds to 15 minutes.

The thickness of the layer is not specifically limited, and can be appropriately selected depending on the purposes, but it is preferably, for example, 1 μm to 300 μm, more preferably 1 μm to 100 μm, especially preferably 1 μm to 50 μm. In the present invention, even such a thin layer can retain the ability to block infrared radiation.

A pre-heating step and a post-heating step typically take place at a heating temperature of 80° C. to 265° C., preferably 90° C. to 250° C.

The pre-heating and the post-heating typically take place for 30 seconds to 600 seconds, preferably 60 seconds to 300 seconds.

The layer formed is subjected to a curing if desired, which improves the mechanical strength of the resulting infrared cut filter.

The curing is not specifically limited, and can be appropriately selected depending on the purposes, but preferably involves, for example, full-field exposure, full-field heating or the like. As used herein, “exposure” means to include irradiation with not only light at various wavelengths but also radiation such as electron beams, X-rays and the like.

Preferably, exposure involves irradiation, and radiations that can be preferably used for exposure specifically include electron beams and ultraviolet or visible light such as KrF, ArF, g-line, h-line, i-line and the like.

Exposure methods include exposure in a stepper, exposure to a high pressure mercury lamp and the like.

The exposure dose is preferably 5 to 3000 mJ/cm².

A full-field exposure method comprises, for example, exposing the entire surface of the layer formed. If the infrared absorbing composition comprises a polymerizable compound, polymerization components in the layer formed of the composition is promoted to be cured by full-field exposure, whereby the layer is further cured so that mechanical strength and durability improve.

The full-field exposure equipment is not specifically limited, and can be appropriately selected depending on the purposes, preferred examples of which include UV exposure systems such as ultra-high pressure mercury lamps.

On the other hand, a full-field heating method comprises heating the entire surface of the layer formed. Full-field heating enhances the film strength of the pattern.

The heating temperature in full-field heating is preferably 120° C. to 250° C., more preferably 120° C. to 250° C. When the heating temperature is 120° C. or more, the heat treatment improves the film strength, and when it is 250° C. or less, the components in the layer can be prevented from decomposing to result in weak and fragile film quality.

The heating period in full-field heating is preferably 3 minutes to 180 minutes, more preferably 5 minutes to 120 minutes.

The full-field heating equipment is not specifically limited, and can be appropriately selected depending on the purposes from known equipment including, for example, dry oven, hot plate, IR heater and the like.

The present invention also relates to a camera module comprising a solid-state image sensor board, and an infrared cut filter, wherein the infrared cut filter is an infrared cut filter of the present invention.

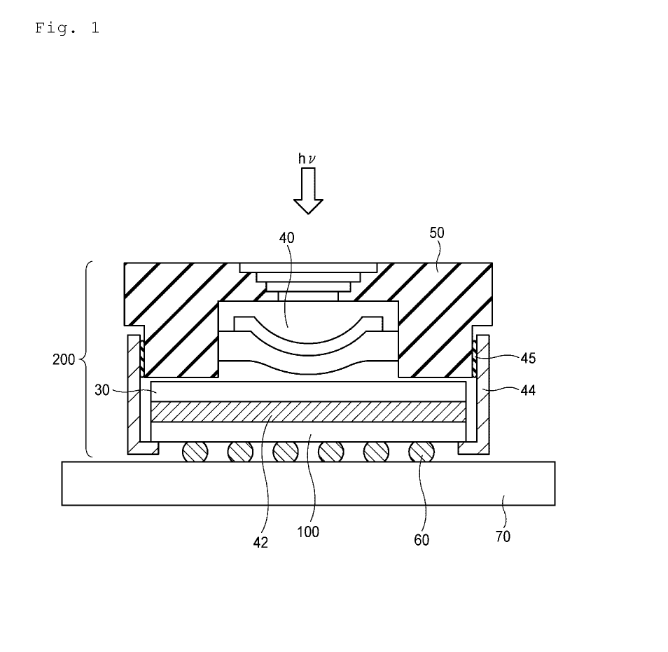

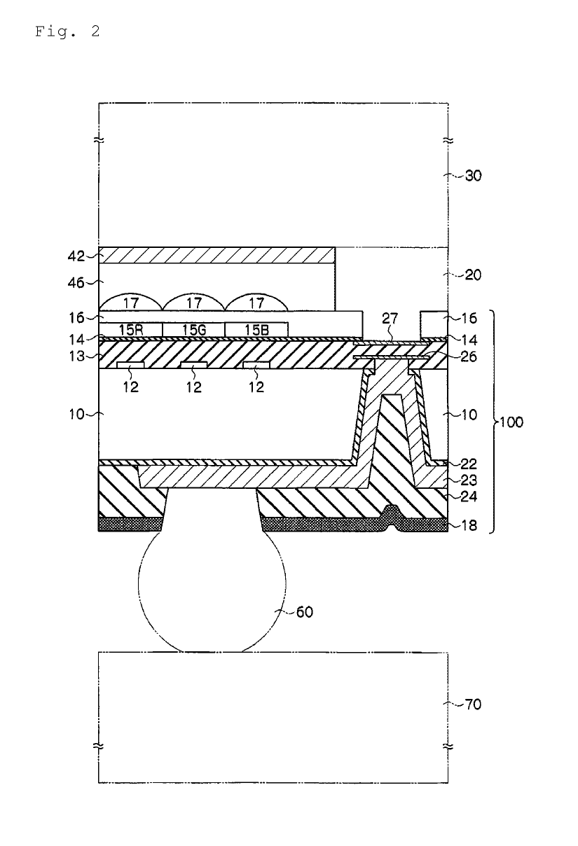

A camera module according to an embodiment of the present invention is explained below with reference to FIG. 1 and FIG. 2, but the present invention is not limited to the following specific example.

It should be noted that throughout FIG. 1 and FIG. 2, common parts are designated by the same numerals.

In the following explanation, “upper”, “upward” and “upper side” mean the remote side viewed from the silicon substrate 10, while “lower”, “downward” and “lower side” mean the proximal side to the silicon substrate 10.

FIG. 1 is a schematic sectional diagram showing the structure of a camera module comprising a solid-state image sensor.

The camera module 200 shown in FIG. 1 is connected to a mounted circuit board 70 via connecting elements consisting of solder balls 60.

Specifically, the camera module 200 comprises a solid-state image sensor board 100 provided with image sensor elements on a first primary surface of a silicon substrate; a planarization layer (not shown in FIG. 1) provided on the side of a first primary surface (the light-capturing side) of the solid-state image sensor board 100; an infrared cut filter 42 provided on the planarization layer; a lens holder 50 provided above the infrared cut filter 42 and holding an imaging lens 40 in the internal space; and a light/electromagnetic shield 44 provided to surround the solid-state image sensor board 100 and a glass substrate 30. The glass substrate 30 (a transparent substrate) may be provided on the planarization layer. These elements are bonded with an adhesive 20, 45.

The present invention also relates to a process for manufacturing a camera module comprising a solid-state image sensor board 100, and an infrared cut filter 42 provided on the light-capturing side of the solid-state image sensor board, the process comprising a forming a layer by applying an infrared absorbing composition of the present invention as described above on the light-capturing side of the solid-state image sensor board. In the camera module according to the present embodiment, the infrared cut filter 42 can be formed by applying the infrared absorbing composition of the present invention on the planarization layer, for example, to form a layer. Coating techniques for forming the infrared cut filter are as described above.

In the camera module 200, incident light hν from outside passes successively through the imaging lens 40, the infrared cut filter 42, the glass substrate 30, and the planarization layer, and then reaches the image sensor elements of the solid-state image sensor board 100.

Although the camera module 200 comprises the infrared cut filter directly provided on the planarization layer, the planarization layer may be omitted and the infrared cut filter may be directly provided on microlenses, or the infrared cut filter may be directly provided on the glass substrate 30, or the glass substrate 30 provided with the infrared cut filter may be laminated to the image sensor board.

FIG. 2 is an enlarged sectional diagram of the solid-state image sensor board 100 shown in FIG. 1.

The solid-state image sensor board 100 comprises image sensors 12, an interlayer insulating layer 13, a base layer 14, color filters 15, an overcoat 16, and microlenses 17 in this order on a first primary surface of a silicon substrate 10. A red color filter 15R, a green color filter 15G, and a blue color filter 15B (hereinafter sometimes collectively referred to as “color filters 15”) and the microlenses 17 are aligned with the image sensors 12. On a second primary surface opposite to the first primary surface of the silicon substrate 10 are provided a light shield layer 18, an insulating layer 22, metal electrodes 23, a solder resist layer 24, internal electrodes 26, and device surface electrodes 27.

On the microlenses 17 are provided a planarization layer 46, and an infrared cut filter 42. As an alternative to the embodiment in which an infrared cut filter 42 is provided on aplanarization layer 46, the infrared cut filter maybe provided on the microlenses 17, or between the base layer 14 and the color filters 15, or between the color filters 15 and the overcoat 16. Especially, it is preferably provided at a location within 2 mm (more preferably within 1 mm) from the surface of the microlenses 17. When it is provided at this location, the infrared radiation shielding ability can be further improved because a forming the infrared cut filter can be simplified so that undesired infrared radiation to the microlenses can be sufficiently blocked.

Details of the solid-state image sensor board 100 can be found in the explanation of the solid-state image sensor board 100 in paragraph 0245 of JPA2012-068418 (or [0407] of the corresponding US Patent Application Publication No. 2012/068292) et seq., the disclosure of which is incorporated herein by reference.

One embodiment of a camera module has been explained with reference to FIG. 1 and FIG. 2, but the one embodiment described above is not limited to the configuration shown in FIG. 1 and FIG. 2.

### EXAMPLES

The following examples further illustrate the present invention. The materials, amounts used, proportions, process details, procedures and the like shown in the following examples can be changed as appropriate without departing from the spirit of the present invention. Thus, the scope of the present invention is not limited to the specific examples shown below. Unless otherwise specified, the “parts” and “%” are based on mass.

### <Infrared Absorbing Materials>

### <<Synthesis of an Infrared Absorbing Dye IR-1>>

### <<<Preparation of an Exemplary Compound (D-17)>>>

An exemplary compound (D-17) was prepared according to Scheme 1 shown below.

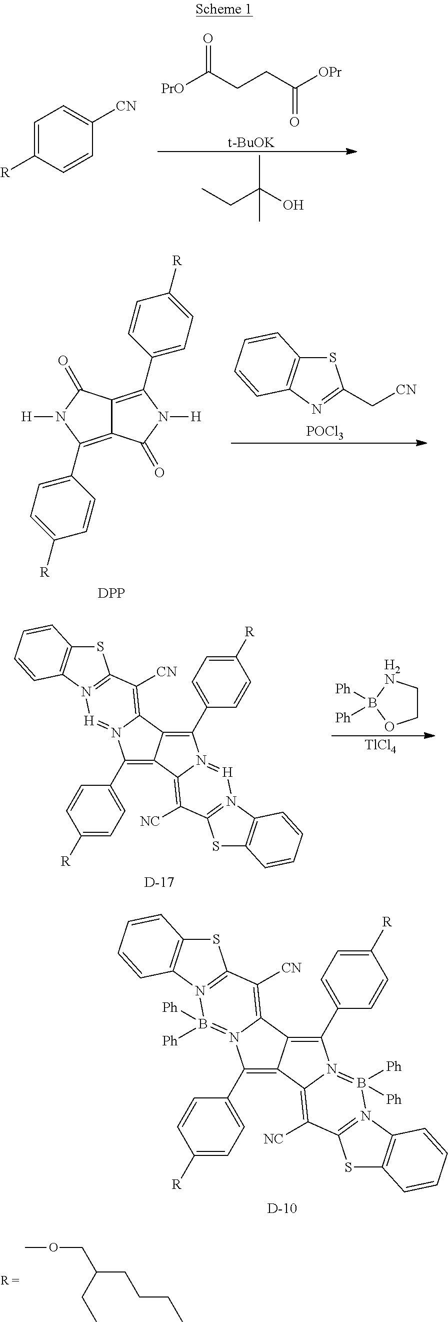

First, a diketopyrrolopyrrole compound (DPP) was synthesized according to the procedure described in U.S. Pat. No. 5,969,154 using 4-(2-ethylhexyloxy)benzonitrile as a starting material.

In 60 mL of toluene were stirred 3 g (1 molar equivalent) of the diketopyrrolopyrrole compound and 1.6 g (2.5 molar equivalents) of pyridine/acetonitrile, and 6.5 g (8 molar equivalents) of phosphorus oxychloride was added, and the mixture was heated under reflux for 4 hours. The reaction mixture was cooled to room temperature (25° C.), and 50 mL of chloroform and 20 mL of water were added, and the mixture was further stirred for 30 minutes. The organic layer was separated by liquid-liquid extraction, and washed with an aqueous sodium hydrogen carbonate solution, and then the solvent was distilled off under reduced pressure. The resulting crude product was purified by column chromatography on silica gel (eluting with chloroform), and recrystallized from a chloroform/acetonitrile solvent to give 3.3 g of the desired compound (D-17) (yield 70%).

1H-NMR (CDCl₃): δ 0.9-1.0 (m, 12H), 1.35-1.6 (m, 16H), 1.8 (m, 2H), 3.95 (d, 4H), 7.1 (d, 4H), 7.4-7.5 (m, 4H), 7.7 (d, 4H), 7.75 (d, 2H), 8.0 (d, 2H).

### <<<Preparation of an Exemplary Compound (D-10)>>>

An exemplary compound (D-10) was prepared according to Scheme 1 shown above.

Titanium chloride (0.9 mL, 3 molar equivalents) was added to a solution of 2-aminomethyl diphenylborinate ester (1.4 g, 3 molar equivalents) in toluene (1.2 M), and the mixture was stirred at an external temperature of 100° C. for 30 minutes. Then, a mixture of the exemplary compound (D-17) (2.3 g) in toluene (0.2M) was added, and the mixture was further stirred for 2 hours while it was heated under reflux. The mixture was cooled to room temperature, and methanol was added, and the precipitating crystals were filtered off and recrystallized from chloroform/methanol to give 3.0 g of an exemplary compound (D-10) (yield 93%).

λmax was 779 nm in chloroform. The molar absorption coefficient was 2.06×10⁵ dm³/mol·cm in chloroform.

¹H-NMR (CDCl₃): δ 0.9-1.0 (m, 12H), 1.35-1.6 (m, 16H), 1.8 (m, 2H), 3.85 (d, 4H), 6.45 (s, 8H), 7.0 (d, 4H), 7.15 (m, 12H), 7.2 (m, 2H), 7.25 (m, 4H+4H), 7.5 (m, 2H).

### <<Synthesis of an Infrared Absorbing Dye IR-2>>

### <<<Preparation of an Exemplary Compound (D-141A)>>>

The exemplary compound (D-141A) shown below was prepared in the same manner as described above for the exemplary compound (D-10) except that the starting material was changed.

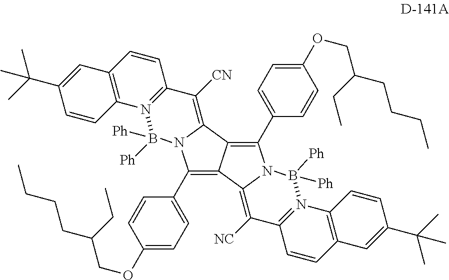

### <<Infrared Absorbing Dye IR-3>>

The exemplary compound 1-2 shown below as described in JPA2002-146254 was used.

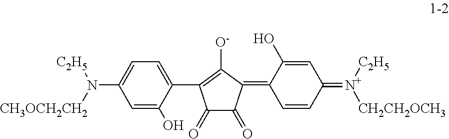

### <Preparation of Microparticle Dispersions>

To any one of the infrared absorbing materials (infrared absorbing dyes IR-1 to IR-3) (6 parts by mass) and a dispersant (Disperbyk 191 from BYK (4 parts by mass)) was added a dispersion medium (water (90 parts by mass)) to 100 parts by mass. Further, 100 parts by mass of zirconia beads having a diameter of 0.1 mmφ were added, and the mixture was treated in a planetary ball mill at 300 rpm for 8 hours, and the beads were separated by filtration to prepare dispersions of microparticles (dispersion IR-1 to dispersion IR-3).

### <Preparation of Infrared Absorbing Compositions>

The infrared absorbing compositions of Examples 1 to 5 and Comparative example 1 described in Table 1 below were prepared by mixing the following components:
Any one of the microparticle dispersions described above: 41.7 parts by mass
A polymerizable compound (any one of the compounds M-1 to M-5 shown below): 16.2 parts by mass
Irgacure 2959 (from BASF): 4.6 parts by mass
Propylene glycol monomethyl ether: 20.0 parts by mass
Water: 17.5 parts by mass
   M-1 to M-3: the compounds shown below
   M-4: ARONIX M-305 (from Toagosei Co., Ltd.)
   M-5: ARONIX M-315 (the compound shown below from Toagosei Co., Ltd.)

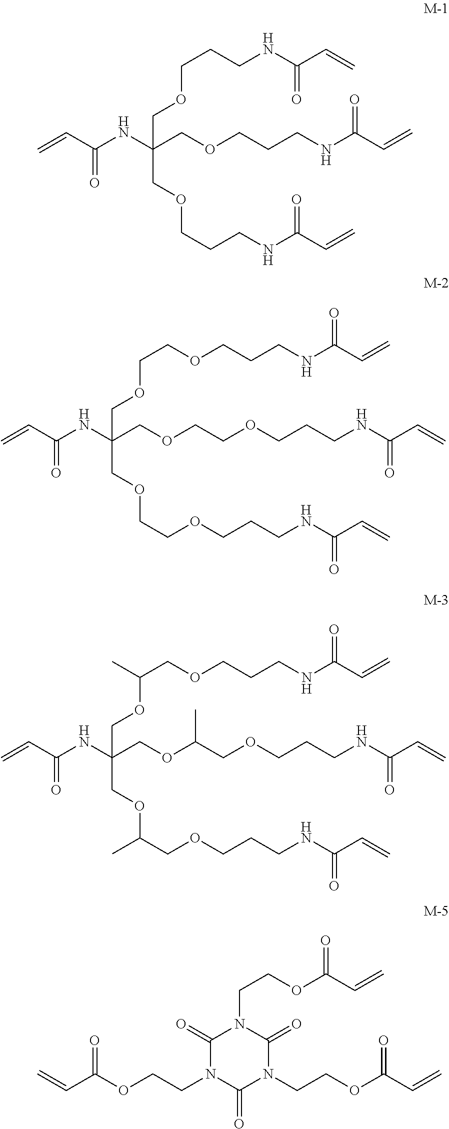

### <The Composition of a Priming Resist Solution>

A solution of a benzyl methacrylate/methacrylic acid (=70/30 [molar ratio]) copolymer in propylene glycol monomethyl ether acetate (20%, weight average molecular weight 30000, available from Fujikura Kasei Co., Ltd. under the brand name Acrybase FF-187): 22 parts
Dipentaerythritol hexaacrylate (available from Nippon Kayaku Co., Ltd. under the brand name KAYARAD DPHA): 6.5 parts
Propylene glycol monomethyl ether acetate (available from Daicel Chemical Industries, Ltd. under the brand name MMPGAC): 13.8 parts
Ethyl 3-ethoxypropionate (available from NAGASE & CO., LTD. as Ethyl 3-ethoxypropionate): 12.3 parts
A halomethyltriazine compound (the compound I shown below) (available from Panchim Ltd. as triazine PP): 0.3 parts

The halomethyltriazine compound (I) is the compound shown below:

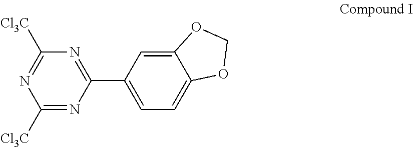

### (Preparation of a Planarization Layer)

This resist solution for a planarization layer was applied on an 8-inch silicon wafer using a spin coater. Then, the coated wafer was heated on a hot plate at a surface temperature of 230° C. for 600 seconds to give a primed wafer.

<Patterning by monolayer photolithography>

### -Preparation of a Coating Layer-

A coating layer having a thickness of about 2.0 μm after drying was formed by applying each infrared absorbing composition obtained as described above on the primed silicon wafer using a spin coater, and then drying it by heating on a hot plate for 120 seconds so that the surface temperature of the coating layer was 100° C.

### -Formation of an Infrared Absorption Pattern for Solid-State Image Sensors-

Then, the dried coating layer was exposed at an exposure dose of 1000 mJ/cm² using an i-line stepper (FPA-3000i5+ from Canon, Inc.) through a mask having a pattern of 2.0 μm square pixels arranged as dots in an area of 10 mm×10 mm on the substrate.

The coating layer exposed in a pattern was developed by the puddle method using a 60% aqueous solution of the organic alkaline developer CD-2000 (from FUJIFILM Electronic Materials Co., Ltd.) at room temperature for 60 seconds, and then rinsed with a spray of pure water while spinning for 20 seconds. Then, it was further washed with pure water. Then, water droplets were blown off by high pressure air, and the substrate was naturally dried and postbaked on a hot plate at 230° C. for 300 seconds to form an infrared absorption pattern on the silicon wafer.

### (Evaluation of Peeling)

The infrared absorption pattern prepared as described above was inspected using the defect inspection system “ComPLUS 3” from Applied Materials Technology Ltd. to detect defect sites and the number of peeling defects was extracted from these defect sites to determine the number of pattern peeling defects. Based on the extracted number of peeling defects, evaluation was made according to the evaluation criteria shown below. Ranks at or higher than B in alphabetical order are suitable for practical uses. For the inspection, 200 areas of 10 mm×10 mm were prepared on the 8-inch wafer and evaluated.

### -Evaluation Criteria-

A: 0≦the number of peeling defects≦10;

B: 11≦the number of peeling defects≦20 (acceptable for practical uses);

C: the number of peeling defects≧21.

TABLE 1

| | Microparticle dispersions | | | | | |
|---|---|---|---|---|---|---|
| | Infrared | | Polymerizable compound | | Peeling defect | |
| | absorbing | Composition | Polymerizable | Composition | | Evaluation |
| | material | ratio | compoun | ratio | Number | result |
| Example 1 | IR-1 | 16.6% | M-1 | 64.6% | 0 | A |
| Example 2 | IR-2 | 16.6% | M-1 | 64.6% | 1 | A |
| Example 3 | IR-1 | 16.6% | M-2 | 64.6% | 3 | A |
| Example 4 | IR-1 | 16.6% | M-3 | 64.6% | 5 | A |
| Example 5 | IR-3 | 16.6% | M-1 | 64.6% | 16 | B |
| Comparative | IR-1 | 16.6% | M-4 | 64.6% | 32 | C |
| Example 1 | | | | | | |

In the table above, the composition ratios of the infrared absorbing materials and the polymerizable compounds refer to the composition ratios based on the total solids of the infrared absorbing compositions.

The results above show that the infrared absorbing compositions of the present invention comprising an infrared absorbing material and a polymerizable compound containing a partial structure represented by formula (1) above allow for preparing infrared absorption patterns having good adhesiveness to substrates on which the infrared absorbing composition are applied.

<Patterning by Multilayer Photolithography> Each infrared absorbing composition was applied on the primed wafer using a spin coater (ACT-8 from Tokyo Electron Limited) to form a coating layer having a thickness of 2.0 μm. The coating layer was heated on a hot plate at 230° C. for 5 minutes to cure it.

A forming a photoresist layer was performed, wherein the positive photoresist “FHi622BC” (from FUJIFILM Electronic Materials Co., Ltd.) was applied on the cured film using a spin coater (ACT-8 from Tokyo Electron Limited), and heated at 100° C. for 2 minutes to form a photoresist layer having a thickness of 2.0 μm.

An image-forming was performed, wherein regions from which the cured film was to be removed were exposed in a pattern at 350mJ/cm² using an i-line stepper (FPA-3000i5+ from Canon, Inc.), and heated at 110° C. for 1 minute, and then developed with the developer “FHD-5” (from FUJIFILM Electronic Materials Co., Ltd.) for 1 minute and then postbaked at 110° C. for 1 minute to remove the photoresist in the regions in which a RED filter array was to be formed, whereby an island pattern having a size of 1.4 μm×1.4 μm was formed.

Subsequently, an etching process was performed using a dry etcher (U-621 from Hitachi High-Technologies Corporation) for 375 seconds under the conditions of an RF power of 800 W, an antenna bias of 400 W, a wafer bias of 200 W, an internal chamber pressure of 4.0 Pa, a substrate temperature of 50° C., and a gas mixture of gas species at flow rates of CF₄: 200 mL/min., O₂: 50 mL/min., and Ar: 800 mL/min.

The etching rate of the infrared absorbing composition under the etching conditions was 322 nm/min. Thus, the infrared radiation absorbing layer that had been formed in the regions to be removed was completely removed during the etching.

A removing the photoresist layer was performed, wherein the photoresist was removed by a stripping process for 120 seconds using the photoresist stripper “MS-230C” (from FUJIFILM Electronic Materials Co., Ltd.).

An infrared absorption pattern was prepared according to the procedure described above.

### (Evaluation of Peeling)

The infrared absorption pattern prepared was evaluated for pattern peeling by the same manner as described above in <Patterning by monolayer photolithography>. The results are shown in the table below.

TABLE 2

| | Microparticle dispersions | | | | | |
|---|---|---|---|---|---|---|
| | Infrared | | Polymerizable compound | | Peeling defect | |
| | absorbing | Composition | Polymerizable | Composition | | Evaluation |
| | material | ratio | compound | ratio | Number | result |
| Example 6 | IR-1 | 16.6% | M-1 | 64.6% | 0 | A |
| Example 7 | IR-2 | 16.6% | M-1 | 64.6% | 1 | A |
| Example 8 | IR-1 | 13.3% | M-1 | 67.9% | 0 | A |
| Example 9 | IR-1 | 24.9% | M-1 | 56.3% | 2 | A |
| Example 10 | IR-1 | 33.2% | M-1 | 48.0% | 2 | A |
| Example 11 | IR-1 | 13.0% | M-1 | 68.2% | 6 | A |
| Example 12 | IR-1 | 34.0% | M-1 | 47.2% | 7 | A |
| Example 13 | IR-1 | 16.6% | M-2 | 64.6% | 2 | A |
| Example 14 | IR-1 | 16.6% | M-3 | 64.6% | 4 | A |
| Example 15 | IR-3 | 16.6% | M-1 | 64.6% | 13 | B |
| Example 16 | IR-1 | 16.6% | M-5 | 64.6% | 17 | B |
| Comparative | IR-1 | 16.6% | M-4 | 64.6% | 41 | C |
| Example 2 | | | | | | |

In the table above, the composition ratios of the infrared radiation absorbing materials and the polymerizable compounds refer to the composition ratios based on the total solids of the infrared absorbing compositions.

The results above show that the infrared absorbing compositions of the present invention comprising an infrared absorbing material and a polymerizable compound containing a partial structure represented by formula (1) above allow for preparing infrared absorption patterns having good adhesiveness to substrates on which the infrared absorbing composition are applied.

### DESCRIPTION OF THE REFERENCE NUMERALS

10, silicon substrate; 12, image sensor; 13, interlayer insulating layer; 14, base layer; 15, color filter; 16, overcoat; 17, microlens; 18, light shield layer; 20, adhesive; 22, insulating layer; 23, metal electrode; 24, solder resist layer; 26, internal electrode; 27, device surface electrode; 30, glass substrate; 40, imaging lens; 42, infrared cut filter; 44, light/electromagnetic shield; 45, adhesive; 46, planarization layer; 50, lens holder; 60, solder ball; 70, circuit board; 100, solid-state image sensor board.

What is claimed is:

1. An infrared absorbing composition comprising: an infrared absorbing material, and a polymerizable compound containing a partial structure represented by formula (1) below: 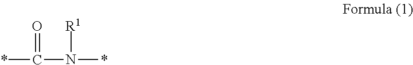
wherein R1 represents a hydrogen atom or an organic group; the asterisk (*) indicates a point of attachment to another atom.

2. The infrared absorbing composition according to claim 1, wherein the polymerizable compound contains two or more partial structures represented by formula (1).

3. The infrared absorbing composition according to claim 1, wherein the polymerizable compound contains two or more polymerizable functional groups.

4. The infrared absorbing composition according to claim 1, wherein the polymerizable compound is a polymerizable compound containing two or more partial structures represented by formula (1-1): 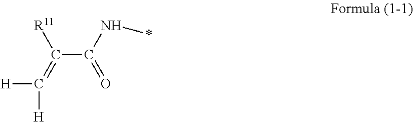
wherein R¹¹ represents a hydrogen atom or methyl group; the asterisk (*) indicates a point of attachment to another atom.

5. The infrared absorbing composition according to claim 1, wherein the polymerizable compound is represented by formula (1-2):
A¹—C—(L¹-A¹)₃ Formula (1-2)
wherein A¹ each independently represents a partial structure represented by formula (1-1), and L¹ represents a divalent linking group: 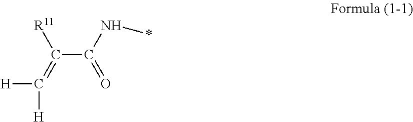
wherein R¹¹ represents a hydrogen atom or methyl group; the asterisk (*) indicates a point of attachment to another atom.

6. The infrared absorbing composition according to claim 1, wherein the polymerizable compound is represented by formula 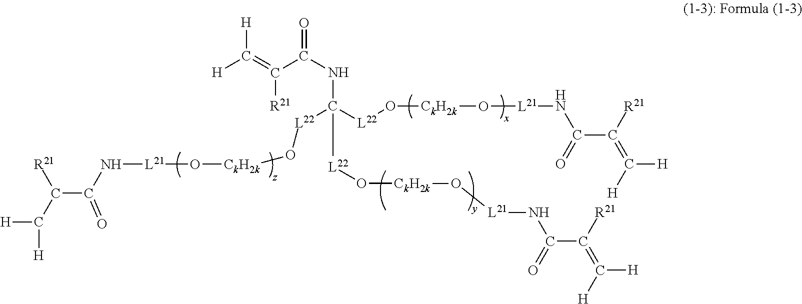
wherein R²¹ each independently represents a hydrogen atom or methyl group; L²¹ represents a straight-chain or branched alkylene group containing 2 to 4 carbon atoms, provided that L²¹ does not adopt a structure in which an oxygen atom and a nitrogen atom at both ends of L²¹ are attached to the same carbon atom of L²¹; L²² represents a divalent linking group; k represents 2 or 3; x, y and z each independently represent an integer of 0 to 6, provided that x+y+z satisfies 0 to 18.

7. The infrared absorbing composition according to claim 1, wherein the infrared absorbing material is at least one of a copper compound and a pyrrolopyrrole dye.

8. The infrared absorbing composition according to claim 6, wherein the infrared absorbing material is a pyrrolopyrrole dye; and the polymerizable compound is represented by formula (1-3).

9. The infrared absorbing composition according to claim 7, wherein the pyrrolopyrrole dye is a compound represented by formula (I) below: 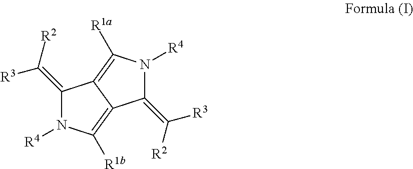
wherein R^{1a} and R^{1b} each independently represent an alkyl group, aryl group or heteroaryl group; R² and R³ each independently represent a hydrogen atom or a substituent and at least one of R² and R³ represents an electron-withdrawing group, or R² and R³ may be joined together to form a ring; R⁴ represents a hydrogen atom, an alkyl group, an aryl group, a heteroaryl group, a substituted boron atom or a metal atom, and may form a covalent bond or a coordinate bond with at least one of R^{1a}, R^{1b} and R³.

10. The infrared absorbing composition according to claim 1, wherein the infrared absorbing material has a maximum absorption at a wavelength of 820 to 880 nm.

11. The infrared absorbing composition according to claim 1, further comprising a solvent.

12. The infrared absorbing composition according to claim 1, which has a solid content 5 to 50% by mass in the infrared absorbing composition.

13. An infrared cut filter using the infrared absorbing composition according to claim 1.

14. A process for manufacturing the infrared cut filter according to claim 13, comprising:
applying the infrared absorbing composition to form an infrared absorption pattern,
wherein the infrared absorbing composition contains water or an aqueous solvent.

15. A camera module comprising a solid-state image sensor board, and the infrared cut filter according to claim 13.

16. A process for manufacturing a camera module comprising a solid-state image sensor board and an infrared cut filter, the process comprising:
coating the infrared absorbing composition according to claim 1.
